(19) United States
(12) Patent Application Publication
(10) Pub. No.: US 2025/0374923 A1
(43) Pub. Date: Dec. 11, 2025

(54) CONTROLLING CITRUS GREENING IN CITRUS PLANTS USING OXYTETRACYCLINE

(71) Applicant: INVAIO SCIENCES, INC., CAMBRIDGE, MA (US)

(72) Inventors: Bhanu Priya HARRISON, Lexington, MA (US); Bruce Michael LUZZI, Yorkville, IL (US); Thomas Michael MALVAR, Jr., North Stonington, CT (US); Danielle Irene ROCK, Cambridge, MA (US); Katia Viana XAVIER, Homestead, FL (US)

(21) Appl. No.: 18/872,775

(22) PCT Filed: Jun. 8, 2023
(86) PCT No.: PCT/US2023/068155

§ 371 Date: Dec. 6, 2024

Related U.S. Application Data
(60) Provisional application No. 63/350,826, filed on Jun. 9, 2022.
(60) Provisional application No. 63/459,925, filed on Apr. 17, 2023.

(51) Int. Cl. A01N 37/44; A01P 1/00

(52) U.S. Cl. CPC A01N 37/44; A01P 1/00

(57) ABSTRACT

The present disclosure relates generally to methods and systems for controlling citrus greening disease in citrus plants, including for example orange trees.

### CROSS-REFERENCE TO RELATED APPLICATIONS

This application claims priority to U.S. Provisional Patent Application No. 63/350,826, filed Jun. 9, 2022, and U.S. Provisional Patent Application No. 63/459,925, filed Apr. 17, 2023, each of which are incorporated herein by reference in their entirety.

### FIELD

The present disclosure relates generally to methods of controlling citrus greening in citrus plants, and more specifically to such methods using a trunk or stem injection system to precisely deliver oxytetracycline to the active vasculature of a citrus plant.

### BACKGROUND

Citrus huanglongbing (HLB), also known as citrus greening disease, is one of the most destructive diseases of citrus worldwide. Citrus greening is a bacterial disease that attacks the vasculature system of citrus trees, and is generally caused by phloem-colonizing bacterium, such as ‘Candidatus Liberibacter asiaticus’ (CLas). The bacteria are carried and transmitted primarily by insect vectors—Asian citrus psyllids. See Florida Department of Agriculture and Consumer Services “Huanglongbing (HLB)/Citrus Greening Disease Information”. There are three forms of greening that have been described. The African form is transmitted by the African citrus psyllid Trioza erytreae, and produces symptoms under cool conditions. The Asian and American forms are transmitted by the Asian citrus psyllid Diaphorina citri, and produce symptoms under warmer conditions. For example, since 2005, HLB has spread through the citrus-producing areas in Florida, reducing citrus production by 75% while more than doubling the cost of production. To date, the commercially available treatments have not been effective in combatting the disease. For example, once infected, the tree hosts the disease burden for life. Continued reinfection from bacteria carrying psyllids increases the disease burden on already infected trees. Abandoned groves without psyllid management are of issue, placing an even higher burden on any neighboring producing blocks.

The bacteria causing citrus greening can infect most citrus cultivars. For example, newly infected trees develop leaves with a blotchy appearance. Chronically infected trees develop leaves that are small and exhibit asymmetrical blotchy mottling. Fruit from infected trees tend to be small and have a poor quality. The juice from such fruit tends to have a low soluble solids content, and taste acidic and bitter.

HLB affects many aspects of a tree's physiology. For example, citrus greening can cause debilitation of a tree's root system, especially feeder roots which inhibits water uptake by the tree, and 30-50% root loss during the early phases of the disease. By the time that symptoms can be found on the canopy, root loss is up to 70%. See Diepenbrock et al. (eds.) “2022-2023 Florida Citrus Production Guide”. University of Florida, Institute of Food and Agricultural Sciences Extension. Evidence also suggests that HLB thickens xylem cell walls, affecting water movement through the tree; and Hamido et al. Plants 2019, 8, 298. These effects in turn also increase the plant's susceptibility to secondary stresses. Disease symptoms include blotchy mottle leaves, stunted growth, corky veins, and root decline. See United States Department of Agriculture. “Citrus Greening”. https://www.aphis.usda.gov/aphis/ourfocus/planthealth/plant-pest-and-disease-programs/pests-and-diseases/citrus/citrus-greening. This disease can also be harmful to fruit production, with fruit that fails to color properly, reduced fruit size, premature fruit drop, reduced quality with a salty and bitter taste, and overall productivity decline.

HLB has particularly affected Florida's citrus industry. Since its first detection in 1998 in Florida, HLB has spread to every citrus producing county in Florida. Currently, Florida is under a state-wide quarantine for citrus greening. Since 1998, HLB has caused an approximately 80% drop in orange production, and an approximately 70% decrease in productivity per acre.

There is currently no practical or commercially available cure for the disease. As such, to prevent the spread of citrus greening, rapid tree removal is usually required. Thus, what is desired are commercially viable treatment solutions for controlling citrus greening.

### BRIEF SUMMARY

In one aspect, provided are methods for controlling citrus greening of a citrus plant, such as a citrus tree or a citrus bush. In some embodiments, the method comprises injecting the infected citrus plant with an injection formulation comprising oxytetracycline (OTC). In some embodiments, the injecting of the injection formulation is performed using an injection system comprising an injection tool. In some embodiments, the injection tool is operatively connected to a fluid delivery unit. In some embodiments, the fluid delivery unit is configured to deliver the injection formulation.

In some embodiments, the injecting of the injection formulation comprises piercing the trunk or stem of the citrus plant using the injection tool of the injection system. In some embodiments, the injecting of the injection formulation comprises delivering at least a portion of the injection formulation from the fluid delivery unit through the injection tool into and no further than the active vasculature of the citrus plant.

In some embodiments, the citrus plant is suffering from citrus greening disease. In some embodiments, the injection formulation is distributed throughout the trunk or stem, and other parts of the citrus plant, such as the leaves and/or fruits. In some variations, the injection formulation is precisely injected into the scion of the citrus plant. In some embodiments, the citrus plant is at least about 1, at least about 2, at least about 3, at least about 4, at least about 5, at least about 10, at least about 15, at least about 20, at least about 30, at least about 40, or at least about 50 years old.

In some embodiments, the delivery unit is a spring-loaded fluid delivery unit. In some embodiments, the delivery unit comprises a pressurized formulation cartridge. In some embodiments, the method comprises replacing the fluid delivery unit with a second fluid delivery unit. In some embodiments, the method comprises delivering at least a portion of the injection formulation from the second fluid delivery unit through the injection tool into and no further than the active vasculature of the citrus plant.

In some embodiments, the injection tool remains in the trunk or stem (including the scion) of the citrus plant over at least one growing season. In some embodiments, the injection tool remains in the trunk or stem (including the scion) of the citrus plant over multiple re-injections. In some embodiments, the trunk or stem of the citrus plant has bark. In some embodiments, the method comprises removing at least a portion of the bark prior to piercing the trunk.

### DESCRIPTION OF THE FIGURES

The present application can be understood by reference to the following description taken in conjunction with the accompanying figures.

FIGS. 1A-1C depict an exemplary injection tool.

FIGS. 2A-2D depict an exemplary multi-port injection tool.

FIG. 3 depicts an exemplary spring-loaded fluid delivery unit.

FIG. 4A depicts an exemplary chassis.

FIG. 4B depicts an exemplary canister.

FIG. 5 depicts harvest weight of trees treated with a hydrochloride salt of OTC (OTC-HCl) as compared to nontreated trees after one growing season.

FIG. 6 depicts harvest weight of trees treated with OTC-HCl as compared to nontreated trees after a second growing season.

FIG. 7 depicts fruit count of trees treated with OTC-HCl as compared to nontreated trees after two growing seasons.

FIG. 8 depicts percent fruit drop of trees treated with OTC-HCl as compared to nontreated trees after two growing seasons.

FIG. 9 depicts Brix of trees treated with OTC-HCl as compared to nontreated trees.

FIG. 10 depicts Brix/acid ratio of trees treated with OTC-Hcl as compared to nontreated trees.

FIG. 11 depicts yield increase of trees after one year of treatment with OTC-HCl as compared to trees treated with a control.

FIG. 12 depicts mean harvest weight of trees treated with OTC-HCl as compared to trees treated with a control.

FIG. 13 depicts mean yield increase of trees at various locations after one growing season of treatment with OTC-HCl.

FIG. 14 depicts mean yield increase of trees at various locations after one growing season of treatment with OTC-HCl as compared to trees treated with a control.

FIGS. 15-21 depict harvest weight of trees at specific locations after one growing season of treatment with OTC-HCl as compared to trees treated with a control.

FIG. 22 depicts fruit count of trees across various locations treated with OTC-HCl as compared to trees treated with controls trees after one growing season.

FIG. 23 depicts percent fruit drop of trees across various locations treated with OTC-HCl as compared to trees treated with controls trees after one growing season.

FIGS. 24-27 depict total fruit residues declines for various treatments of trees with OTC-HCl.

FIG. 28 depicts average total residue in fruit at various days after last application of OTC-HCl.

FIG. 29 depicts average total fruit residue in fruit at various days after last application of OTC-HCl.

FIG. 30 depicts a graph show effect of OTC-HCl treatment as compared to water with respect to yield increase.

FIG. 31 depicts a graph show effect of OTC-HCl treatment as compared to nontreated control with respect to yield increase.

FIG. 32 compares the effect of OTC-HCl treatment on lowering citrus greening and leaf mottling, as compared to nontreated controls.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

In some aspects, provided here are methods for controlling citrus greening disease in a citrus plant. In some embodiments, citrus greening disease in these citrus plants are controlled by precisely injecting a liquid formulation comprising Oxytetracycline or a salt thereof into the active vasculature of the plant. In some variations, the liquid formulation is injected no further than the active vasculature of the plant. The systems used in the methods described herein minimize the amount of leakage of the Oxytetracycline into the surrounding environment.

### Injection Formulations

In one aspect, provided are injection formulations suitable for use in controlling citrus greening in a citrus plant. In certain embodiments, the injection formulation is water soluble. In some embodiments, the injection formulation comprises Oxytetracycline or a salt thereof. In certain variations, the injection formulation further comprises nutrients. In one variation, the injection formulation comprises micronutrients.

In some embodiments, the injection formulation comprises a stock formulation or a commercially available formulation. In some embodiments, the injection formulation comprises a stock formulation diluted with water or other solvents or formulations. In some embodiments, the injection formulation comprises a commercially available formulation diluted with water or other solvents or formulations. In some embodiments, stock formulations comprise commercially available formulations. In some variations, commercially available formulations or stock formulations may be diluted and/or further formulated for use in the methods described herein.

In some embodiments, the OTC or a salt thereof is present in the injection formulation at a concentration of between about 1.25 mg/mL and about 1.75 mg/mL. In some embodiments, the OTC or a salt thereof is present in the injection formulation at a concentration of between about 0.1 mg/mL and about 10 mg/mL, between about 0.1 mg/mL and about 5 mg/mL, between about 0.25 mg/mL and about 5 mg/mL, between about 0.25 mg/mL and about 2.5 mg/mL, between about 0.5 mg/mL and about 2.5 mg/mL, between about 0.75 mg/mL and about 2.5 mg/mL, between about 1 mg/mL and about 2 mg/mL, or between about 1.25 mg/mL and about 1.75 mg/mL. In some embodiments, the OTC or a salt thereof is present in the injection formulation at about 1.6 mg/mL. In some embodiments, the OTC or a salt thereof is present in the injection formulation at a concentration of about 0.25, 0.5, 0.75, 1, 1.1, 1.2, 1.3, 1.4, 1.5, 1.6, 1.7, 1.8, 1.9, 2, 2.25, 2.5, 2.75, 3, 3.5, 4, 4.5, 5, 6, 7, 8, 9, or 10 mg/mL.

In some embodiments, the injection formulation comprises OTC or a salt thereof. In some embodiments, the injection formulation comprises a hydrochloride salt of OTC (OTC-HCl). In some embodiments, OTC-HCl is present in the injection formulation in an amount between about 0.625 mg/mL and about 1.125 mg/mL. In some embodiments, the OTC-HCl is present in the injection formulation at a concentration of about 0.25 mg/mL, about 0.5 mg/mL, about 0.75 mg/mL, about 1 mg/mL, about 1.1 mg/mL, about 1.2 mg/mL, about 1.3 mg/mL, about 1.4 mg/mL, about 1.5 mg/mL, about 1.6 mg/mL, about 1.7 mg/mL, about 1.8 mg/mL, about 1.9 mg/mL, about 2 mg/mL, about 2.25 mg/mL, about 2.5 mg/mL, about 2.75 mg/mL, about 3 mg/mL, about 3.5 mg/mL, about 4 mg/mL, about 4.5 mg/mL, about 5 mg/mL, about 6 mg/mL, about 7 mg/mL, about 8 mg/mL, about 9 mg/mL, or about 10 mg/mL.

In some embodiments, the injection formulation comprises OTC or a salt thereof. In some embodiments, OTC or a salt thereof is present in the injection formulation in an amount between about 35 mg and about 150 mg. In some embodiments, the OTC or salt thereof is present in the injection formulation in an amount between about 37.5 mg and about 100 mg. In some embodiments, the OTC or salt thereof is present in the injection formulation in an amount between about 75 mg and about 150 mg. In some embodiments, the OTC or salt thereof is present in the injection formulation in an amount between about 37.5 mg and about 125 mg, between about 37.5 mg and about 100 mg, between about 37.5 mg and about 75 mg, or between about 37.5 mg and about 50 mg. In some embodiments, the OTC or salt thereof is present in the injection formulation in an amount between about 37.5 mg and about 150 mg, between about 50 mg and about 150 mg, between about 75 mg and about 150 mg, between about 100 mg and about 150 mg, or between about 125 mg and about 50 mg. In some embodiments, the OTC or salt thereof is present in the injection formulation in an amount of about 37.5 mg, about 50 mg, about 75 mg, about 100 mg, about 125 mg, or about 150 mg.

In some variations of the foregoing, the injection formulation comprises an aqueous solution of OTC or a salt thereof. In certain variations of the foregoing, the injection formulation comprises a salt of OTC. In certain variations, the salt is a hydrochloride salt. Any suitable OTC formulations, including commercially available OTC formulations, may be employed in the methods and systems herein. For instance, one suitable example of OTC formulations that may be used with the injection systems herein is ArborBiotech™, which is a systemic water-soluble injectable antibiotic for the control or suppression of Huanglongbing (HLB, Citrus Greening) caused by Candidatus Liberibacter asiaticus (Clas) in orange trees (Crop Subgroup 10-10A). ArborBiotech™ comprises OTC hydrochloride which makes up 39.60% of the formulation (which is equivalent to 36.7% OTC), and other ingredients which make up the remaining 60.40% of the formulation.

In some embodiments, the injection formulation comprises an aqueous solution of OTC or a salt thereof. In some embodiments, the volume of the aqueous solution of OTC or a salt thereof of the injection formulation is between about 30 mL and about 240 mL. In some embodiments, the volume of the aqueous solution of OTC or a salt thereof of the injection formulation is between about 30 mL and about 60 mL, between about 60 mL and about 120 mL, or between about 120 mL and about 240 mL.

In some embodiments, the amount of OTC or salt thereof present in the injection formulation is determined by the trunk (e.g., scion) diameter about 10 cm above the graft of the tree receiving the injection formulation. In some embodiments, the trunk diameter of the tree is between about 2 cm and about 6 cm and the injection formulation comprises about 37.5 mg of OTC or salt thereof. In some embodiments, the trunk diameter of the tree receiving the injection formulation is greater than about 6 cm and the injection formulation comprises about 75 mg of OTC or salt thereof. In some embodiments, the trunk diameter of the tree receiving the injection formulation is greater than about 6 cm and the injection formulation comprises about 150 mg of OTC or salt thereof.

In some embodiments, the maximum amount of OTC or salt thereof injected into a tree in a growing season is determined by the trunk (e.g., scion) diameter about 10 cm above the graft of the of the tree receiving the injection formulation. In some embodiments, the trunk diameter of the tree is between about 2 cm and about 6 cm and the maximum amount of OTC or salt thereof injected into the tree in a growing season is about 75 mg. In some embodiments, the trunk diameter of the tree is greater than about 6 cm and the maximum amount of OTC or salt thereof injected into the tree in a growing season is about 150 mg.

In some embodiments, the injection formulation comprises an aqueous solution of OTC or a salt thereof and the volume of the aqueous solution is determined by the trunk (e.g., scion) diameter about 10 cm above the graft of the tree receiving the injection formulation. In some embodiments, the trunk diameter of the tree is between about 2 cm and about 6 cm and the volume of the aqueous solution of OTC or a salt thereof is between about 30 mL and about 60 mL. In certain embodiments, the trunk diameter of the tree is between about 2 cm and about 6 cm, the volume of the aqueous solution of OTC or a salt thereof is between about 30 mL and about 60 mL, and the OTC or salt thereof is present in a concentration between about 0.625 mg/mL and about 1.125 mg/mL.

In some embodiments, the trunk diameter of the tree receiving the injection formulation is greater than about 6 cm and the volume of the aqueous solution of OTC or a salt thereof is between about 60 mL and about 240 mL. In some embodiments, the trunk diameter of the tree receiving the injection formulation is greater than about 6 cm and the volume of the aqueous solution of OTC or a salt thereof is between about 60 mL and about 120 mL. In certain embodiments, the trunk diameter of the tree receiving the injection formulation is greater than about 6 cm, the volume of the aqueous solution of OTC or a salt thereof is between about 60 mL and about 120 mL, and the OTC or salt thereof is present in a concentration between about 0.625 mg/mL and about 1.125 mg/mL. In some embodiments, the trunk diameter of the tree receiving the injection formulation is greater than about 6 cm and the volume of the aqueous solution of OTC or a salt thereof is between about 120 mL and about 240 mL. In certain embodiments, the trunk diameter of the tree receiving the injection formulation is greater than about 6 cm, the volume of the aqueous solution of OTC or a salt thereof is between about 120 mL and about 240 mL, and the OTC or salt thereof is present in a concentration between about 0.625 mg/mL and about 1.125 mg/mL.

### Treatment Protocol

In some embodiments, the method comprises injecting the citrus plant with an injection formulation described herein.

In some embodiments, the method comprises measuring the trunk diameter. In some embodiments, the method comprises measuring the trunk circumference, the trunk diameter, or both. In some embodiments, the trunk circumference or the trunk diameter is measured from about 10 cm above the graft.

In some embodiments, injecting the injection formulation of any of the methods described herein is performed by injecting the injection formulation into the rootstock of the crop. In some embodiments, the crop is a citrus plant. In some embodiments, the citrus plant is an orange tree.

In some embodiments, injecting the injection formulation of any of the methods described herein is performed by injecting the injection formulation into the trunk (e.g., scion) of the crop. In some embodiments, the crop is a citrus plant. In some embodiments, the citrus plant is an orange tree.

In some embodiments, injecting the injection formulation or any of the methods described herein are performed 4 times a year. In some embodiments, injecting the injection formulation or any of the methods described herein are performed 1, 2, 3, 4, 5, 6, 7, 8, 9, 10, 11, or 12 times a year. In some embodiments, injecting the injection formulation or any of the methods described herein are performed more than 1 time, more than 2 times, more than 3 times, more than 4 times, more than 5 times, more than 6 times, more than 7 times, more than 8 times, more than 9 times, or more than 10 times a year. In some embodiments, injecting the injection formulation or any of the methods described herein are performed less than 2 times, less than 3 times, less than 4 times, less than 5 times, less than 6 times, less than 7 times, less than 8 times, less than 9 times, or less than 10 times a year. In some embodiments, injecting the injection formulation or any of the methods described herein are performed twice a year.

In some embodiments, the timing of injecting the injection formulation or any of the methods described herein is determined by the growing season of a crop. For example, in some embodiments, the timing of injecting the injection formulation or any of the methods described herein is determined by harvest date or pre-harvest interval (PHI) of a crop. In some embodiments, the crop is a citrus crop. In certain embodiments, the citrus crop is oranges.

In some embodiments, injecting the injection formulation or any of the methods described herein is performed 1 time a year. In some embodiments, injecting the injection formulation or any of the methods described herein is performed 1 time a year between about 0 and 60 days after the final harvest of a crop. In some embodiments, injecting the injection formulation or any of the methods described herein is performed 1 time a year at least about 120 days prior to harvest (e.g., PHI) of a crop. In some embodiments, the crop is a citrus crop. In certain embodiments, the citrus crop is oranges.

In some embodiments, injecting the injection formulation or any of the methods described herein is performed 2 times a year. In some embodiments, injecting the injection formulation or any of the methods described herein is performed 2 times a year and the first injection time is performed about 120 days prior to harvest (e.g., PHI) of a crop. In some embodiments, injecting the injection formulation or any of the methods described herein is performed 2 times a year and the first injection time is performed between about 0 and 60 days after the final harvest of a crop. In some embodiments, injecting the injection formulation or any of the methods described herein is performed 2 times a year and the second injection time is performed between about 60 days after the first injection time and about 120 days before harvest (e.g., PHI) of a crop. In some embodiments, injecting the injection formulation or any of the methods described herein is performed 2 times a year and the second injection time is performed at least about 90 degrees around the circumference of the tree trunk from the location of the first injection time. In some embodiments, the crop is a citrus crop. In certain embodiments, the citrus crop is oranges.

In some embodiments, injecting the injection formulation or any of the methods described herein are performed around March, around May, around June, around September, and/or around OTCober. In some embodiments, injecting the injection formulation or any of the methods described herein are performed around January, around February, around March, around April, around May, around June, around July, around August, around September, around October, around November, around December, or any combination thereof.

In some embodiments, injecting the injection formulation or any of the methods described herein are performed on citrus trees, such as orange trees. In some embodiments, the orange trees are late season orange varietals (e.g., Valencia, OLL8). In some embodiments, the orange trees are late season orange varietals (e.g., Valencia, OLL8) and injecting the injection formulation or any of the methods described herein are performed are performed around May, around OTCober, or any combination thereof. In some embodiments, the orange trees are short season orange varietals (e.g., Hamlin). In some embodiments, the orange trees are short season orange varietals (e.g., Hamlin) and injecting the injection formulation or any of the methods described herein are performed are performed around March, around April, around June, around August, or any combination thereof.

In some embodiments, injecting the injection formulation or any of the methods described herein are performed after the final harvest of the previous growing season of the crop.

In some embodiments, injection close to harvest is avoided. In some embodiments, injecting the injection formulation or any of the methods described herein are performed at least about 16 weeks before harvesting. In some embodiments, injecting the injection formulation or any of the methods described herein are performed at least about 12 weeks before harvesting. In some embodiments, injecting the injection formulation or any of the methods described herein are performed about 4 weeks, about 5 weeks, about 6 weeks, about 7 weeks, about 8 weeks, about 9 weeks, about 10 weeks, about 11 weeks, about 12 weeks, about 13 weeks, about 14 weeks, about 15 weeks, about 16 weeks, about 17 weeks, about 18 weeks, about 19 weeks, or about 20 weeks before harvesting; or between about 4 weeks and about 20 weeks before harvesting.

In some embodiments, injecting the injection formulation or any of the methods described herein are performed at the end of the previous growing season of a crop. In some embodiments, the crop is citrus. In some embodiments, the crop is orange trees. In some embodiments, the end of the previous growing season is after the final harvest of the previous growing season.

In some embodiments, injecting the injection formulation or any of the methods described herein are performed twice during the growing season. In some embodiments, injecting the injection formulation or any of the methods described herein is performed once (e.g., the injection formulation) after the final harvest of the previous growing season and once (e.g., the second injection formulation) at least about 120 days prior to harvest of the crop. In some embodiments, the injection formulation and the second formulation are the same. In some embodiments, the injection formulation and the second formulations are different. In some embodiments, the crop is citrus. In some embodiments, the crop is orange trees.

In some embodiments, injecting the injection formulation or any of the methods described herein is performed once after the end of the previous growing season (e.g., the injection formulation) and once between about 1 and about 60 days prior to harvest (e.g., the second injection formulation). In some embodiments, injecting the injection formulation or any of the methods described herein is performed (i) once as soon as possible after the end of the previous growing season and (ii) once between about 1 and about 60 days after (i) and at least about 120 prior to harvest (e.g., PHI).

In some embodiments, the volume of the injection formulation injected into the citrus plant as described herein is between about 30 mL and about 240 mL, between about 30 mL and about 120 mL, between about 50 mL and about 100 mL, between about 30 mL and about 60 mL, between about 60 mL and about 240 mL, between about 60 mL and about 120 mL, or between about 120 mL and about 240 mL; or about 30 mL, about 60 mL, about 120 mL, or about 240 mL. In some embodiments, total volume of injection formulation injected into a tree during one growing season is between about 30 mL and about 240 mL.

### Citrus Plant & Diseases

In some embodiments, the citrus plant is a citrus tree or a citrus bush. In some variations, the citrus tree is an orange tree, a lemon tree, a lime tree, a grapefruit tree, or a pomelo tree. In certain variations, the citrus plant is a lemon bush, or a lime bush. In one variation, the citrus bush is a dwarf citrus bush. In other variations, the citrus tree is a mature tree.

In some variations, the citrus plants are suffering from citrus greening disease caused by Liberibacter spp. (e.g., L. asiaticus, L. africanus, L. americanus). In some variations, the disease is transmitted by the Asian citrus psyllid, Diaphorina citri, and the African citrus psyllid, Trioza erytreae.

In some embodiments, the infected citrus plant exhibits at least one symptom caused by citrus greening disease. In some embodiments, the citrus plant to which the injection formulation is applied is infected. In some embodiments, the citrus plant to which the injection formulation is applied is not infected. In some embodiments, the methods described herein are used only for citrus plants with one or more symptoms caused by citrus greening disease. Such symptoms may include any one or more of the following:
asymmetrical yellowing of veins and adjacent tissues; splotchy mottling of the entire leaf; premature defoliation; dieback of twigs; decay of feeder rootlets and lateral roots; decline in vigor; stunted growth, bear multiple off-season flowers; produce small, irregularly shaped fruit with a thick, pale peel that remains green at the bottom and tastes bitter.

In some variations, to assess the efficacy of the injection formulations used in the citrus plant, one or more of the following are evaluated: Brix analysis of fruit, fruit yield, fruit drop, OTC residue levels in fruit, OTC concentrations in citrus leaves, effects of the treatment on Clas titers in leaves, and overall plant health.

In some embodiments, this disclosure provides methods for enhancing or maintaining plant health in the citrus plants and grove. In some such embodiments, this disclosure provides methods for treating diseased plants and/or methods for controlling the bacteria, fungi, viruses and/or other pathogens that cause citrus greening disease in the citrus plants. In further such embodiments, this disclosure provides methods for treating citrus plants whose xylem and/or phloem have been invaded by disease-causing bacteria, fungi, viruses, and/or other pathogens, for controlling the bacteria, fungi, virus and/or other pathogens causing the disease, and for preventing diseases by preventing sufficient colonization of the plant by the disease causing pathogens such as bacteria, fungi, and viruses.

In some embodiments, controlling citrus greening disease in citrus plants using the systems, devices and methods herein includes reducing the bacterial concentration (titer) in the vascular system. In some variations, controlling citrus greening disease in citrus plants using the systems, devices and methods herein includes reducing the bacterial concentration (titer) in the vascular system by strengthening the plant's natural defense system. In certain embodiments, the systems, devices and methods herein can provide a treatment that leads to suppression of the disease to a level where recovery of citrus production occurs. In some variations, bacterial titer refers to the bacterial concentration in the vascular system of the infected plant. Bacterial titer may be measured using any suitable methods and techniques known in the art. For example, in one variation, bacterial titer is measured through quantitative PCR. In one variation, Clas titer is measured, e.g., using any suitable techniques known in the art.

In some variations, the treatment protocols provided herein can (i) reduce fruit drop; (ii) increase Brix in the fruit; and/or (iii) increase fruit yield. In some embodiments, the treatment protocols provided herein can (i) reduce fruit drop by at least about 10%, (ii) increase Brix by at least about 5%, and/or (iii) increase fruit yield by at least about 10%. In certain variations, the treatment protocols provided herein can (i) reduce fruit drop by at least about 5%, 7.5%, 10%, 12.5%, 15%, 17.5%, 20%, 22.5%, 25%, 30%, 40%, or 50%, or between about 5% and about 50%, between about 5% and about 40%, between about 5% and about 30%, between about 5% and about 25%, between about 10% and about 25%, between about 15% and about 25%, or between about 17.5% and about 22.5%; (ii) increase Brix by at least about 1%, 2%, 3%, 4%, 5%, 6%, 7%, 8%, 9%, or 10%, or between about 1% and about 10%, between about 2% and about 9%, between about 3% and about 8%, between about 4% and about 8%, between about 5% and about 8%, or between about 6% and about 8%, and/or (iii) increase fruit yield by at least about 5%, 10%, 15%, 20%, 25%, 30%, 35%, 40%, 45%, 50%, 55%, 60%, 65%, 70%, 80%, or 90%, or between about 5% and about 90%, between about 10% and about 80%, between about 20% and about 70%, between about 30% and about 70%, between about 40% and about 70%, between about 50% and about 70%, or between about 55% and about 65%. Overall, in one variation, the treatment protocols provided herein can improve recovery of plant health, and yield a healthier, more resilient grove.

In some variations, the fruit collected from the plants to which the injection formulation is administered has an average OTC residue less than 0.01 ppm. In some variations, the fruit collected from the plants to which the injection formulation is administered has an average OTC residue less than 0.0001 ppm, less than about 0.001 ppm, less than about 0.01 ppm, less than about 0.015 ppm, less than about 0.02 ppm, less than about 0.025 ppm, less than about 0.03 ppm, less than about 0.04 ppm, or less than about 0.05 ppm, or no detectable levels of OTC. In other variations, the average OTC residue is between about 0.001 ppm and about 0.01 ppm.

In some variations, the fruit collected from the plants to which the injection formulation is administered has an average OTC residue less than 0.01 ppm between about 1 day and about 90 days after the last injection of the injection formulation. In some variations, the fruit collected from the plants to which the injection formulation is administered has an average OTC residue less than 0.01 ppm between about 1 day and about 250 days after the last injection of the injection formulation. In some variations, the fruit collected from the plants to which the injection formulation is administered has an average OTC residue less than 0.01 ppm between about 1 day and about 225 days after the last injection of the injection formulation. In some variations, the fruit collected from the plants to which the injection formulation is administered has an average OTC residue less than 0.01 ppm between about 1 day and about 125 days after the last injection of the injection formulation. In some variations, the fruit collected from the plants to which the injection formulation is administered has an average OTC residue less than 0.01 ppm between about 1 day and about 115 days after the last injection of the injection formulation. In some variations, the fruit collected from the plants to which the injection formulation is administered has an average OTC residue less than 0.01 ppm between about 1 day and about 90 days after the last injection of the injection formulation. In some variations, the fruit collected from the plants to which the injection formulation is administered has an average OTC residue less than 0.01 ppm between about 1 day and about 60 days after the last injection of the injection formulation.

In some variations, the fruit collected from the plants to which the injection formulation is administered has an average OTC residue less than 0.1 ppm. In some variations, the fruit collected from the plants to which the injection formulation is administered has an average OTC residue less than 0.1 ppm between about 1 day and about 35 days after the last injection of the injection formulation. In some variations, the fruit collected from the plants to which the injection formulation is administered has an average OTC residue less than 0.1 ppm between about 1 day and about 10 days after the last injection of the injection formulation. In some variations, the fruit collected from the plants to which the injection formulation is administered has an average OTC residue less than 0.1 ppm between about 1 day and about 7 days after the last injection of the injection formulation.

In some variations, fruit on the plants to which the injection formulation comprising OTC or a salt thereof is administered has an average OTC residue of about 0.05 ppm between about 0 days and about 3 days after injection of the injection formulation. In some variations, fruit on the plants to which the injection formulation is administered has an average OTC residue of about 0.05 ppm between about 0 days and about 3 days after injection of the injection formulation which decreases to less than about 0.01 ppm about 90 days after injection of the injection formulation. In some variations, fruit on the plants to which the injection formulation is administered has an average OTC residue of about 0.5 ppm between about 0 days and about 3 days after injection of the injection formulation which decreases to less than about 0.01 ppm about between about 90 days and about 125 days after injection of the injection formulation.

In some variations, leaves on the plants to which the injection formulation comprising OTC or a salt thereof is administered have an average OTC residue less than 0.1 ppm between about 0 days and about 60 days after injection of the injection formulation. In some variations, the average OTC residue of leaves on the plants to which the injection formulation is administered peak between about 1 day and about 3 days after injection of the injection formulation before declining to less than about 0.1 ppm about 60 days after injection of the injection formulation. In some variations, OTC residue of leaves on the plants to which the injection formulation is administered remain for longer than plants receiving spray treatments of OTC or a salt thereof, which have an average OTC residue less than about 0.1 ppm about 28 days after receiving the spray treatment. In some variations, the average OTC residue of leaves on the plants to which the injection formulation is administered is about twice as high as the average OTC residue of leaves on plants receiving spray treatments of OTC or a salt thereof between about 1 day and about 3 days after injection of the injection formulation.

In some variations, roots of the plants to which the injection formulation comprising OTC or a salt thereof is administered have an average OTC residue less than about 0.1 ppm. In some variations, roots of the plants to which the injection formulation comprising OTC or a salt thereof is administered have an average OTC residue less than about 0.1 ppm between about 0 days and about 21 days after injection of the injection formulation.

In some embodiments, the average OTC residue refers to residues of OTC or a salt thereof. In some embodiments, the average OTC residue refers to residues of OTC or a salt thereof and one or more metabolites of OTC or a salt thereof. For example, the average OTC residue may include 4-Epi-Oxytetracycline, a metabolite of OTC.

In some variations, the average fruit drop for the plants to which the injection formulation is administered is less than about 20. In some variations, the average fruit drop for the plants to which the injection formulation is administered is less than about 25, less than about 20, less than about 15, or less than about 10; or between about 10 and about 25 or between about 10 and about 20.

In some variations, the average fruit yield for the plants to which the injection formulation is administered is at least about 55 lbs. In some variations, the average fruit yield for the plants to which the injection formulation is administered is at least about 35 lbs, at least about 40 lbs, at least about 45 lbs, at least about 50 lbs, at least about 55 lbs, at least about 60 lbs, at least about 65 lbs, at least about 70 lbs, at least about 75 lbs, at least about 80 lbs, or least about 85 lbs per plant, or between about 30 and about 90 lbs, or between about 35 and about 85 lbs per plant.

In some variations, an average Brix for the plants to which the injection formulation is administered is at least about 7.5. In some variations, an average Brix for the plants to which the injection formulation is administered is at least about 7.5, at least about 7.6, at least about 7.7, at least about 7.8, at least about 7.9, at least about 8, or at least about 8.5; or between about 7 and about 9, or between about 7.5 and about 8.5.

In other embodiments, controlling citrus greening disease in citrus plants using the systems, devices and methods herein includes at least partially or fully restoring phloem functionality of the infected citrus plants. In certain embodiments of the foregoing, this may restore the plant's productive capacity and overall plant health including the metabolomic profile of the plant. In some variations, metabolomic profile of the plant may be used to measure the plant health.

In yet other embodiments, controlling citrus greening disease in citrus plants using the systems, devices and methods herein includes at least partially or fully restoring yield capacity. In some variations, yield over the plant lifecycle is increased as compared to untreated control plants.

In certain embodiments, the method comprises delivering a formulation comprising oxytetracycline, and optionally one or more nutrients, into a citrus plant. In certain embodiments the method comprises precision delivery (also referred to as “precision injection”) of a formulation into the citrus plant. Precision delivery refers to delivering the formulation only or substantially only into a target location in the citrus plant. For example, in some embodiments, the target location is the active vasculature of the plant. In certain embodiments, the method comprises injecting an injection formulation into and no further than the active vasculature of the plant. In some variations, the active vasculature of the plant is the xylem and/or the phloem. In one variation, the active vasculature is active xylem (such as sapstream) and phloem. In further embodiments, precision delivery involves delivering the formulation into the active vasculature of the citrus plant while minimizing damage to the plant relative traditional forms of injection drilling systems. In yet other embodiments, precision delivery involves using a system that can be configured to deliver formulation into and no further than the active vasculature of a plant.

In certain embodiments, the method comprises injecting an injection formulation comprising oxytetracycline into a citrus plant, for example into the active vasculature of the plant using precision delivery devices and systems, such as those referenced herein. In some such embodiments, the methods comprise precise injection of an injection formulation comprising oxytetracycline into the plant. In certain embodiments, the methods comprise injecting an injection formulation, for example precise injection of an injection formulation, comprising oxytetracycline into the plant, for example into the active vasculature of the plant prone to disease caused by citrus greening disease.

In some embodiments, this disclosure also provides systems and devices for delivering injection formulations to the interior of the plant. In some embodiments, the systems comprise an injection tool operatively connected to a fluid delivery unit, wherein the injection tool is configured for precision delivery of the injection formulation to a target location inside the plant. In some embodiments, the systems are configured for precision delivery of an injection formulation into the active vasculature of a citrus plant. In some embodiments, the fluid delivery unit further comprises the formulation. In other embodiments, the system comprises an injection tool, a fluid delivery unit, and a source of source of formulation in fluid communication with the fluid delivery unit.

### Injection System

In some embodiments, the injecting of the injection formulation is performed using an injection system comprising an injection tool operatively connected to a fluid delivery unit, wherein the fluid delivery unit is configured to deliver the injection formulation. In some embodiments, the injecting of the injection formulation comprises piercing the trunk or stem of the citrus plant using the injection tool of the injection system. In some embodiments, the injecting of the injection formulation comprises delivering at least a portion of the injection formulation from the fluid delivery unit through the injection tool into and no further than the active vasculature of the plant.

In some embodiments, an injection system is used to deliver the injection formulation to a citrus plant. In some variations, the injection system comprises: an injection tool operatively connected to a fluid delivery unit. In certain variations, the injection tool comprises: a base having at least one inlet; and a body comprising at least one distribution reservoir, and at least one outlet. In some embodiments, the injection system comprises: an injection tool, a fluid delivery unit, and a source of active ingredient (including, for example, nutrients) formulated as a liquid.

In some embodiments, the injection systems described herein comprise an injection tool connected to a prefilled and pressurized application container holding the injection formulation comprising OTC or a salt thereof in aqueous solution mixed for application. In certain variations, the injection system is configured to precisely deliver the aqueous injection formulation into the vascular system of the tree. In certain variations, when the liquid injection formulation comprising OTC or a salt thereof is used with the injection systems described herein, the negative impact of Candidatus Liberibacter asiaticus on tree health and fruit yield and quality is surprisingly reduced.

In some embodiments, the injection formulation is dispensed into the into the vascular system of a tree at least 1 day, at least 2 days, at least 3 days, at least 4 days, at least 5 days, at least 6 days, or at least 7 days.

In some variations, the body is shaped to pierce the plant, such as the trunk or stem of the plant. In certain variations, the body is in the shape of a blade. In certain variations, the body has a cutting edge at the tip of the body, and the width of the cutting edge is narrower than width of the body in the area connected to the base.

In certain variations, the body comprises: at least one outlet that receives the injection formulation from the at least one inlet, and at least one distribution reservoir that retains the injection formulation proximate to adjacent tissue of the plant. In certain variations, the fluid delivery unit is configured to store and deliver the injection formulation. In certain variations, the fluid delivery unit comprises a pressurized container (e.g., a pressurized canister).

In some embodiments, the method comprises: piercing the trunk or stem of a citrus plant using the injection tool of the injection system; and delivering at least a portion of the injection formulation from the fluid delivery unit through the injection tool to the vasculature of the citrus plant. In some variations, the injection formulation is delivered pneumatically or hydraulically.

In some embodiments, the injection formulation is precisely delivered. In some variations, the injection formulation is delivered into and no further than the active vasculature of the plant when the injection tool is inserted into the trunk or stem of the plant. In one variation, the injection formulation is delivered into and no further than the xylem, or the phloem or both of the plant when the injection tool is inserted into the trunk or stem of the plant.

In other embodiments, precisely delivering the injection formulation comprises inserting the injection tool into and no further than the active vasculature of the plant. In certain variations, precisely delivering the injection formulation comprises inserting the body of the injection tool into and no further than the active vasculature of the plant. In one variation, precisely delivering the injection formulation comprises inserting the injection tool such that the distribution reservoir is positioned in and no further than the active vasculature of the plant.

In some variations, the methods deliver at least about 50%, at least about 60%, at least about 70%, at least about 80%, at least about 90%, at least about 95%, at least about 96%, at least about 97%, at least about 98% or at least about 99% of the injection formulation into to the active vasculature of the plant. In one variation, the methods deliver at least about 50%, at least about 60%, at least about 70%, at least about 80%, at least about 90%, at least about 95%, at least about 96%, at least about 97%, at least about 98% or at least about 99% of the injection formulation into the xylem and/or phloem of the plant. In some variations of the foregoing, the methods deliver the injection formulation into to the active vasculature of the plant in an average maximum time of less than about 10 minutes, or less than about 5 minutes.

In certain embodiments, the method comprises injecting injection formulation into the vasculature through one or more sites on the trunk or stem of the plant. In embodiments where the formulation is injected through multiple injection sites, a plurality of the injection systems described herein may be used. In some embodiments where the formulation is injected through multiple injection sites, the system comprises multiple injection tools operatively connected to a single fluid delivery unit.

In some variations, the method further comprises removing at least a portion of the bark around the injection site, e.g., prior to piercing the trunk.

The methods described herein generally provide one or more commercial advantages over the methods currently known in the art to control citrus greening disease. For example, advantages include one or more of a faster return to the production yields pre- infection, fast response (e.g., curing), lower volumes of formulation needed, less loss of formulation to the environment, less damage to the plant, response in old plants, response in plants with significant disease symptoms.

In embodiments, the injection systems comprise an injection tool, a fluid delivery unit, and an injection formulation source. In operation, the injection tool is operatively connected to the fluid delivery unit such that injection formulation flows from the source through the injection tool into the plant. In some embodiments, the source of injection formulation is independent of the fluid delivery unit. In other embodiments, the source of injection formulation is integral with the fluid delivery unit. Certain embodiments of injection systems suitable for use in the methods described herein are described in further detail below.

### Injection Tool

In some embodiments, the injection tool includes a body, at least a portion of which is designed to be lodged into the trunk or stem of a plant. The body has a channel system (e.g., having one or more channels) through which the injection formulation can flow. In some variations, the liquid formation enters the injection tool through one or more inlets, and exits the injection tool through one or more outlets through which the injection formulation is delivered to the interior of the plant. In some embodiments, the lodged portion of the body is sized and shaped to reduce or minimize damage to the target plant when inserted into the plant, while maintaining efficient functionality of the injection tool in delivering the desired dosing of the injection formulation over the desired time period directly to the sapwood and not the heartwood of the trunk of the plant. In other embodiments, the lodged portion of the body is sized and shaped to reduce damage to the target plant when inserted into the plant, as compared to traditional drilling injection system. In some embodiments, the injection tool is configured to penetrate the scion or rootstock of a tree up to a depth of about 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, or 15 mm. In some embodiments, the penetration depth of the injection tool is selected based on scion diameter. In some embodiments, an injection tool configured to penetrate the scion or rootstock of a tree up to a depth of about 4 mm, 4.5 mm, 5 mm, 5.5 mm, 6 mm, 6.5 mm, 7 mm, or 7.5 mm is selected to inject a tree having a scion diameter less than 6 cm. In some embodiments, an injection tool configured to penetrate the scion or rootstock of a tree up to a depth of about 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, or 15 mm is selected to inject a tree having a scion diameter greater than 6 cm.

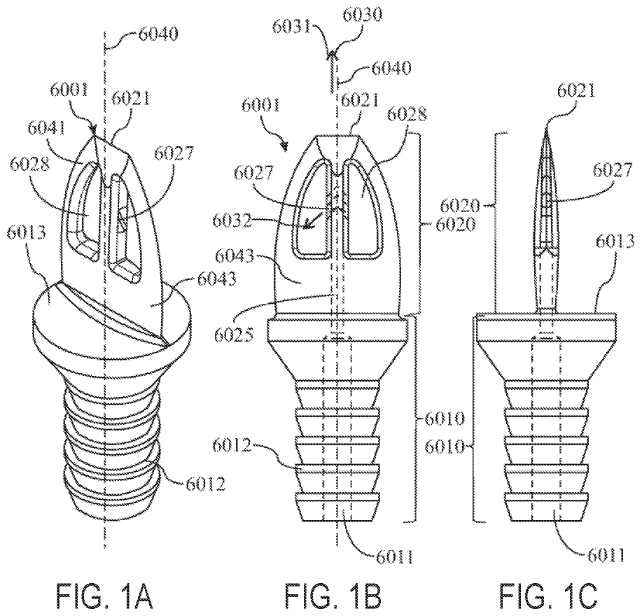

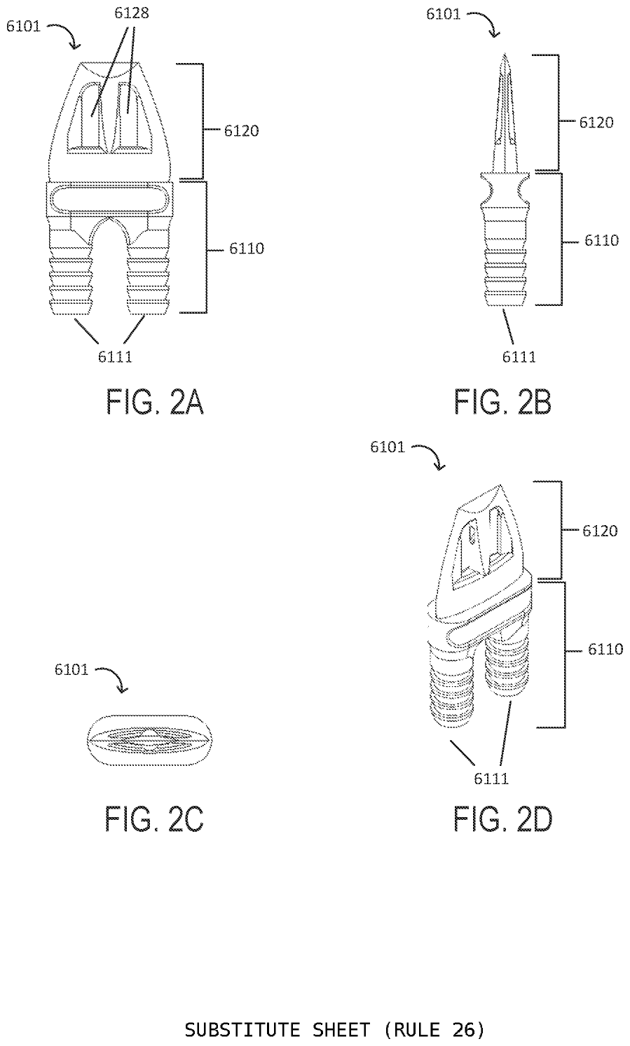

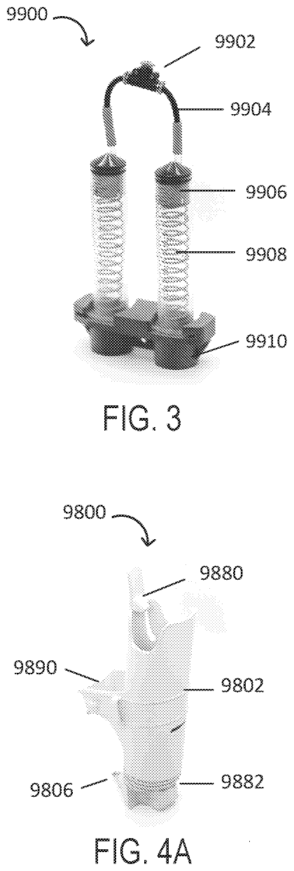

In some variations, exemplary injection tools are depicted in FIGS. 1A-1C and 2A-2D. With reference to FIGS. 1A-1C, depicted is an exemplary injection tool 6001 having a base 6010 and a body 6020. The body 6020 includes a cutting element. For example, in one variation, the body 6020 includes a cutting edge along the front face 6021, directed distally away from the base 6010. In some variations, the outlets 6027 and distribution reservoirs 6028 are within the body 6020. As shown in the side view of FIG. 3C, the body 6020 increases in thickness from the distal portion 6041 toward the proximal portion 6043 and the base 6010.

In some embodiments, the base 6010 optionally includes a ribbed outer structure 6012, such as attachment cleats, to facilitate grasping of the base 6010 and to securely connect the injection tool 6001 with a fluid delivery unit. In some variations, at the transition between the base 6010 and the body 6020, a step is provided. The step forms an abutting face 6013. The abutting face 6013 extends relative to (e.g., away from) the body 6020. During insertion of the injection tool 6001, the abutting face 6013 contacts the tree and arrests further advancement of the injection tool 6001 into the tree. In some variations, a larger abutting face 6013 facilitates use with smaller and less robust trees having a comparably soft shell or boundary. The relatively large abutting face distributes forces from insertion over the correspondingly large face 6013 and thereby minimizes trauma to the tree. In certain variations, the abutting face 6013 further provides an enclosing face for the injection tool 6001 for establishing a robust coupling with the tree.

As shown in FIGS. 1B and 1C, the base 6010 includes an inlet 6011, which receives the injection formulation from the fluid delivery unit. The injection formulation travels through a main channel 6025, and is released through the outlets 6027 into the distribution reservoirs 6028. As shown in FIGS. 1A and 1B, outlets 6027 open transversely into the respective distribution reservoirs 6028.

The injection formulation is delivered from the outlets 6027 transversely, for instance relative to the longitudinal body axis 6040 and the corresponding insertion direction 6030, into the distribution reservoirs 6028. The distribution reservoirs 6028 retain the injection formulation in residence proximate to adjacent plant tissues. In the example shown in FIG. 3B, the outlets 6027 extend proximally toward the base 6010 and transverse relative to the insertion direction 6030 of the injection tool 6001.

Because of the relatively small profile of the injection tool 6001, the injection tool 6001 is readily inserted and installed in comparably small trees or less robust trees having a softer plant material (e.g., tissues or the like). For instance, the injection tool 6001 is configured for softened striking or manual pressing of the injection tool 6001 into the tree.

As shown in FIG. 1B, the injection tool 6001 is inserted along an insertion direction 6030 corresponding to the longitudinal body axis 6040 of the injection tool 6001. The body 6020 of the injection tool 6001 spreads the tree material aside as the injection tool 6001 is inserted into the tree. Spreading of the tree material minimizes trauma to the tree material, and in some examples facilitates enhanced uptake of formulations.

As further shown in FIG. 1B, the outlets 6027 extend in outlet direction 6032 toward the distribution reservoirs 6028. The outlet direction 6032 is transverse to the insertion direction 6030 (and the longitudinal body axis 6040). For example, in some variations, the outlet direction 6032 is misaligned with the insertion direction 6030 (and the longitudinal body axis 6040) with an angle of 125 degrees or the like. The transverse orientation of the outlets 6027 isolates the outlets 6027 from tree material otherwise introduced into the outlet channels with insertion. Further, the distribution reservoirs 6028 facilitate positioning of the outlets 6027 within the body profile, for instance recessing the outlets 6027 from an exterior of the body profile.

With reference to FIGS. 2A-2D, depicted is another exemplary injection tool 6101 having a base 6110 and a body 6120. The base 6110 and the body 6120 share similar features as described above for base 6010 and body 6120. For example, the body 6120 may include a cutting edge along the front face of the body. The body further includes outlets that distribute the injection formulation into distribution reservoirs 6128 within the body 6120.

However, unlike the injection tool 6001 depicted in FIGS. 1A-1C, injection tool 6101 has a base 6110 that includes two inlets 6111, which receives the injection formulation from the fluid delivery unit. The injection formulation travels through a main channel, and is released through the outlets into the distribution reservoirs 6128.

In some variations, the injection tool may have a plurality of inlets operatively connected to a fluid delivery unit. In certain variations, the injection tool has two, three or four inlets operatively connected to a fluid delivery unit.

With reference again to FIGS. 2A, 2B and 2D, the base 6010 optionally includes a ribbed outer structure, such as attachment cleats, to facilitate grasping of the base 6010 and to securely connect the injection tool 6001 with a fluid delivery unit.

In some embodiments, the size of the injection tool is determined by the trunk (e.g., scion) diameter. For example, in certain variations, the size of the injection tool is determined by the trunk (e.g., scion) diameter about 10 cm above the graft of the of the tree receiving the injection formulation.

In some embodiments, the injection systems described herein comprising the exemplary injection tools depicted in the figures do not require drilling a hole or installing a valve in the trunk or stem of the plant before injecting the injection formulation.

### Fluid Delivery Unit

In some embodiments, the fluid delivery unit and the source of the injection formulation are integrated into a formulation cartridge, such as a pressurized container. In certain variations, the formulation cartridge is a pressurized canister. In operation, the injection formulation flows from the fluid delivery unit through the injection tool into the plant. WO 2020/021041 and WO 2021/152093, each of which is hereby incorporated by reference, provides additional embodiments and variations of the injection systems and components thereof, including in the figures therein.

In some embodiments, the injection systems or components thereof used in the methods described herein are as depicted in the figures. In some embodiments, the systems are configured to administer injection formulation comprising one or more active ingredients (including, for example, nutrients) to a plant or a part thereof. In certain embodiments, such systems are mounted onto a post portion of a plant, for example to a trunk or stem of the plant.

In some embodiments, the methods provided herein include installing an injection tool in the trunk, stem, root or limb of a plant, operatively connecting the injection tool to a fluid delivery unit, and activating the fluid delivery unit to initiate the flow of fluid from the fluid delivery unit through the injection tool and into the plant. In other embodiments, two or more injection tools are installed into one or more of the stem, trunk, roots, limbs or the like of a plant to minimize trauma to the plant (e.g., by minimizing the size of a unitary hole in the tree or spacing the tools apart along the plant). In some such embodiments, the two or more injection tools are operatively connected to the same fluid delivery unit. In other such embodiments the two or more injection tools are operatively connected to independent fluid delivery unit.

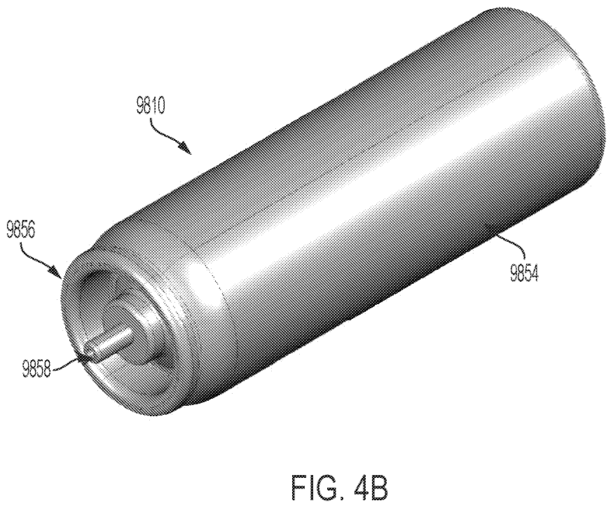

In some variations, the fluid delivery unit comprises a spring-loaded fluid delivery unit. In certain variations of the foregoing, the spring-loaded fluid delivery unit is configured to operate at a pressure between 1.5-3 bar. In other variations, the fluid delivery unit comprises a fluid delivery unit comprising a pressurized container (e.g., a pressurized canister). Examples of suitable fluid delivery unit include the variations depicted in FIGS. 3 and 4A.

With reference to FIG. 3, depicted is an exemplary spring-loaded fluid delivery unit 9900. Base 9912 holds two springs 9908 within syringes 9910. A piston with a rubber seal divides the injection formulation from the spring chamber. Attached to each syringe body 9910 is a tube 9904 connected to a t-shaped connector 9902. The injection tip (not depicted in FIG. 3) is connected to the connector 9902. The spring-loaded fluid delivery unit 9900 can be filled through connector 9902.

In other exemplary embodiments, the spring-loaded fluid delivery unit may have a base holding one or multiple springs within one or multiple corresponding syringes. The design of the spring-loaded fluid delivery unit may vary based on the pressure, volume, time or other appropriate parameters to deliver the injection formulation. For example, in some variations, multiple springs (such as a dual spring) may be employed in the fluid delivery unit to allow for injection of a higher volume of the injection formulation. In other variations, a single spring with a larger syringe may be used, but may affect pressure range employed to inject the injection formulation.

With reference to FIG. 4A, depicted is an exemplary chassis-style injection system comprising a system housing for integrating various components of the injection system, including an injection tool. Injection system 9800 includes a chassis 9802 that has a delivery interface connecting to the injection tool 9806. The delivery interface includes, but is not limited to, passages, channels, tubing, reservoirs or the like that interconnect the formulation cartridge (not depicted in FIG. 4A) and the injection tool 9806. The delivery interface extends to the injection tool and fluidly communicates the formulation to the distribution reservoirs of the injection tool. A flange 9880 may engage the formulation cartridge, resulting in activating the cartridge and maintaining it in place. In some embodiments, the position of the flange is adjustable to accommodate different length canisters and/or to permit activation at a desired time. As further depicted in FIG. 4A, in some embodiments, at least a portion of chassis includes a flexible portion 9882, for example to mitigate damage to the tip during installation. In one variation, in the exemplary injection system depicted in FIG. 4A, the chassis 9802 can further include an anchor 9890 to further facilitate coupling with the tree. For instance, a belt, strap or the like may be passed through the anchor 9890 to hold the injection system 9800 in place along the tree.

With reference to FIG. 4B, a pressurized formulation cartridge 9810 is depicted. The exemplary cartridge 9810 includes a formulation container 9854 including a formulation reservoir therein having a quantity of the injection formulation. A cartridge cap 9856 encloses the formulation container 9854. A cartridge discharge port 9858 extends from the formulation cartridge 9810. Optionally, in certain variations, the cartridge discharge port includes an opening feature configured to transition from a closed configuration to an open configuration. The opening feature includes, but is not limited to, a valve, membrane or the like that is opened prior to coupling with the chassis of the injection system.

In some embodiments, once the injection tool is inserted into the trunk or stem of the citrus plant, the injection tool may remain untouched and in place over multiple re-injections. In certain embodiments, the method further comprises: replacing the fluid delivery unit with a second fluid delivery unit; and delivering at least a portion of the injection formulation from the second fluid delivery unit through the injection tool into and no further than the active vasculature of the citrus plant. In some variations, the injection tool remains in the trunk or stem of the citrus plant over at least one growing season, at least two growing seasons, or at least three growing seasons.

### Enumerated Embodiments

A first embodiment is related to a method for controlling citrus greening in a citrus plant, wherein the citrus plant further has an active vasculature that runs through the trunk or stem to other parts of the citrus plant, the method comprising: injecting an injection formulation comprising oxytetracycline (OTC) or a salt thereof into the active vasculature of the plant to control citrus greening in the citrus plant.

A second embodiment relates to a method of the first embodiment, wherein the active vasculature into which the injection formulation is injected is active vasculature in the trunk or stem of the citrus plant.

A third embodiment relates to a method of embodiment 1 or 2, wherein the citrus plant is a citrus tree.

A fourth embodiment relates to a method of any one of embodiments 1 to 3, wherein, after injection, the citrus plant has at least about 5%, at least about 10%, or at least about 15%, or between about 10% and about 25% reduced fruit drop as compared to an untreated citrus plant.

A fifth embodiment relates to a method of any one of embodiments 1 to 4, wherein, after injection, the citrus plant produces fruit with at least about 1%, at least about 2%, at least about 3%, at least about 4%, or at least about 5%, between about 5% and about 10% increased Brix as compared to an untreated citrus plant.

A sixth embodiment relates to a method of any one of embodiments 1 to 5, wherein, after injection, the citrus plant has at least about 10%, at least about 20%, at least about 30%, at least about 40%, or at least about 50%, or between about 40% and about 75% increased fruit yield as compared to an untreated citrus plant.

A seventh embodiment relates to a method of any one of embodiments 1 to 6, wherein the injecting of the injection formulation is performed using an injection system comprising an injection tool operatively connected to a fluid delivery unit, wherein the fluid delivery unit is configured to deliver the injection formulation.

An eighth embodiment relates to a method of embodiment 7, wherein the injecting of the injection formulation comprises: piercing the trunk or stem of the citrus plant using the injection tool of the injection system; and delivering at least a portion of the injection formulation from the fluid delivery unit through the injection tool into and no further than the active vasculature of the citrus plant.

A nineth embodiment relates to a method of any one of the preceding embodiments, wherein the injection formulation is distributed throughout the trunk or stem and other parts of the citrus plant.

A tenth embodiment relates to a method of embodiment 9, wherein the other parts of the citrus plant comprise fruits.

An eleventh embodiment relates to a method of embodiment 9 or 10, wherein the other parts of the citrus plant comprise leaves.

A twelfth embodiment relates to a method of any one of embodiments 7 to 11, wherein the fluid delivery unit is a spring-loaded fluid delivery unit.

A thirteenth embodiment relates to a method of any one of embodiments 7 to 12, wherein the delivery unit comprises a pressurized formulation cartridge.

A fourteenth embodiment relates to a method of any one of embodiments 7 to 13, further comprising: replacing the fluid delivery unit with a second fluid delivery unit; and delivering at least a portion of the injection formulation from the second fluid delivery unit through the injection tool into and no further than the active vasculature of the citrus plant.

A fifteenth embodiment relates to a method of any one of embodiments 7 to 14, wherein the injection tool remains in the trunk or stem of the citrus plant over at least one growing season.

A sixteenth embodiment relates to a method of any one of embodiments 7 to 15, wherein the injection tool remains in the trunk or stem of the citrus plant over multiple re-injections.

A seventeenth embodiment relates to a method of any one of embodiments 7 to 16, wherein the trunk of the citrus plant has bark, and the method further comprises: removing at least a portion of the bark prior to piercing the trunk.

An eighteenth embodiment relates to a method of any one of the preceding embodiments, wherein the citrus plant is an orange tree.

A nineteenth embodiment relates to a method of embodiment 18, wherein the orange tree to which the injection formulation is applied has fruit with an average oxytetracycline (OTC) residue of less than about 0.01 ppm.

A twentieth embodiment relates to a method of embodiment 18 or 19, wherein the method results in the orange tree to which the injection formulation is applied having an average fruit drop of less than about 20.

A twenty-first embodiment relates to a method of any one of embodiments 18 to 20, wherein the method results in the orange tree to which the injection formulation is applied having an average fruit yield of at least about 40 lbs per plant, or between about 45 and about 90 lbs per plant.

A twenty-second embodiment relates to a method of any one of embodiments 18 to 21, wherein the method results in the orange tree to which the injection formulation is applied having an average Brix of at least about 7.5.

A twenty-third embodiment relates to a method of any one of embodiments 18 to 22, wherein the method results in the orange tree to which the injection formulation is applied having fruit with an average decrease in fruit drop by at least about 10% as compared to an orange tree to which the injection formulation has not been applied.

A twenty-fourth embodiment relates to a method of any one of embodiments 18 to 23, wherein the method results in the orange tree to which the injection formulation is applied having fruit with an average increase in Brix by at least about 5% as compared to an orange tree to which the injection formulation has not been applied.

A twenty-fifth embodiment relates to a method of any one of embodiments 18 to 24, wherein the method results in the orange tree to which the injection formulation is applied having fruit with an average increase in fruit yield by at least about 10% as compared to an orange tree to which the injection formulation has not been applied.

A twenty-sixth embodiment relates to a method of increasing fruit harvest yield in a citrus plant, wherein the citrus plant has an active vasculature that runs through the trunk or stem to other parts of the citrus plant, the method comprising: injecting an injection formulation comprising oxytetracycline (OTC) or a salt thereof into the active vasculature of the citrus plant, wherein the injection formulation is injected into the citrus plant one or more times during a growing season to increase fruit harvest yield in the citrus plant over one or more growing seasons of injection as compared to fruit harvest yield in an untreated citrus plant.

A twenty seventh embodiment relates to a method of embodiment 26, wherein the average fruit harvest yield is increased by over 100% as compared to average fruit harvest yield in an untreated citrus plant after two growing seasons.

A twenty eighth embodiment relates to a method of embodiment 26, wherein the average fruit harvest yield is increased by over 30% as compared to average fruit harvest yield in an untreated citrus plant after one growing season.

A twenty-nineth embodiment relates to a method of any one of embodiments 26 to 28, wherein the injection formulation is injected once a growing season.

A thirtieth embodiment relates to a method of embodiment 29, wherein the injection formulation comprises 150 mg of OTC or a salt thereof in solution.

A thirty first embodiment relates to a method of any one of embodiments 26 to 28, wherein the injection formulation is injected twice a growing season.

A thirty second embodiment relates to a method of any embodiment 31, wherein the injection formulation comprises 75 mg of OTC or a salt thereof in solution.

A thirty third embodiment relates to a method of any one of embodiments 26 to 28, wherein the injection formulation is injected three times a growing season.

A thirty fourth embodiment relates to a method of embodiment 33, wherein the injection formulation comprises 37.5 mg of OTC or salt thereof in solution, injected in two applications; or the injection formulation comprises 75 mg of OTC or salt thereof in solution, injected in one application.

A thirty fifth embodiment relates to a method of any one of embodiments 26 to 34, wherein between 100 mg and 200 mg of OTC or salt thereof is injected into the citrus plant in a growing season.

A thirty sixth embodiment relates to a method of embodiment 35, wherein about 150 mg of OTC or salt thereof is injected in the citrus plant in a growing season.

A thirty seventh embodiment relates to a method of any one of embodiments 26 to 36, wherein the fruit harvest yield is determined based on harvest weight, fruit count, and/or fruit drop.

A thirty eighth embodiment relates to a method of embodiment 37, wherein the harvest weight is increased as compared to harvest weight in an untreated citrus plant after one or more growing seasons.

A thirty nineth embodiment relates to a method of embodiment 38, wherein the harvest weight is increased by over about 50% as compared to harvest weight in an untreated citrus plant after one growing season.

A fortieth embodiment relates to a method of embodiment 38 or 39, wherein the harvest weight is increased by over about 100% as compared to harvest weight in an untreated citrus plant after two growing seasons.

A forty-first embodiment relates to a method of any one of embodiments 37 to 40, wherein the fruit count is increased as compared to fruit count in an untreated citrus plant after one or more growing seasons.

A forty-second embodiment relates to a method of any one of embodiment 41, wherein the fruit count is increased by over about 10% as compared to fruit count in an untreated citrus plant after one growing season.

A forty-third embodiment relates to a method of any one of embodiments 41 or 42, wherein the fruit count is increased by over about 100% as compared to fruit count in an untreated citrus plant after two growing seasons.

A forty-fourth embodiment relates to a method of any one of embodiments 37 to 43, wherein the fruit drop is reduced as compared to an untreated citrus plant after one or more growing seasons.

A forty-fifth embodiment relates to a method of any one of embodiments 37 to 44, wherein the fruit harvest yield is increased by over about 25% as compared to fruit harvest yield of an untreated citrus plant after one growing season.

A forty-sixth embodiment relates to a method of any one of embodiments 26 to 41, wherein Brix in fruit harvested from the citrus plant is increased as compared to Brix of fruit harvested in an untreated citrus plant.

A forty-seventh embodiment relates to a method of any one of embodiments 26 to 42, wherein Brix/acid ratio in fruit harvested from the citrus plant is increased as compared to Brix/acid ratio of fruit harvested in an untreated citrus plant.

A forty eighth embodiment relates to a method of treating citrus greening and leaf mottling in citrus plant with a scion diameter range of about 1.3 to about 5.1 cm, wherein the citrus plant has an active vasculature that runs through the trunk or stem to other parts of the citrus plant, the method comprising: injecting an injection formulation comprising oxytetracycline (OTC) or a salt thereof into the active vasculature of the citrus plant, wherein the injection formulation is injected into the citrus plant one or more times a growing season to reduce citrus greening and reduce leaf mottling.

A forty-nineth embodiment relates to a method of embodiment 48, wherein the citrus plant is injected once with an injection formulation comprising 12.5 mg oxytetracycline hydrochloride.

A fiftieth embodiment relates to a method of embodiment 48, wherein the citrus plant is injected once with an injection formulation comprising 37.5 mg oxytetracycline hydrochloride.

A fifty first embodiment relates to a method of embodiment 48, wherein the citrus plant is injected two times with an injection formulation comprising 18.75 mg oxytetracycline hydrochloride.

A fifty-second embodiment relates to a method of embodiment 48, wherein the citrus plant is injected three times with an injection formulation comprising 18.75 mg oxytetracycline hydrochloride.

A fifty third embodiment relates to a method of embodiment 48, wherein the citrus plant is injected two times with an injection formulation comprising 37.5 mg oxytetracycline hydrochloride.

A fifty fourth embodiment relates to a method of any one of embodiments 51-53, wherein the injections are spaced about 30 days apart.

A fifty fifth embodiment relates to a method of any one of embodiments 51-53, wherein the injections are spaced about 45 days apart.

A fifty sixth embodiment relates to a method of any one of embodiments 51-53, wherein the injections are spaced about 60 days apart.

A fifty seventh embodiment relates to a method of any one of embodiments 48-56, wherein the citrus plant is injected in rootstock.

A fifty eighth embodiment relates to a method of any one of embodiments 48-56, wherein the citrus plant is injected in the scion.

A fifty-nineth embodiment relates to a method of embodiment 57, wherein the rootstock is injected with an injection tool that reaches but does not exceed a depth of 6.5 mm.

A sixtieth embodiment relates to a method of embodiment 58, wherein the scion is injected with an injection tool that reaches but does not exceed a depth of 6.5 mm.

A sixty first embodiment relates to a method of treating citrus greening and leaf mottling in citrus plant with a scion diameter greater than 6 cm, wherein the citrus plant has an active vasculature that runs through the trunk or stem to other parts of the citrus plant, the method comprising: injecting an injection formulation comprising oxytetracycline (OTC) or a salt thereof into the active vasculature of the citrus plant, wherein the injection formulation is injected into the citrus plant one or more times a growing season to reduce citrus greening.

A sixty second embodiment relates to a method of embodiment 61, wherein the citrus plant is injected once with an injection formulation comprising 150 mg oxytetracycline hydrochloride.

A sixty third embodiment relates to a method of embodiment 61, wherein the citrus plant is injected two times with an injection formulation comprising 75 mg oxytetracycline hydrochloride.

A sixty fourth embodiment relates to a method of embodiment 61, wherein the citrus plant is injected three times with an injection formulation comprising 50 mg oxytetracycline hydrochloride.

A sixty fifth embodiment relates to a method of any one of embodiments 63 and 64, wherein the injections are spaced about 30 days apart.

A sixty sixth embodiment relates to a method of any one of embodiments 63 and 64, wherein the injections are spaced about 45 days apart.

A sixty seventh embodiment relates to a method of any one of embodiments 63 and 64, wherein the injections are spaced about 60 days apart.

A sixty eighth embodiment relates to a method of any one of embodiments 61-67, wherein the citrus plant is injected in rootstock.

A sixty-nineth embodiment relates to a method of any one of embodiments 61-67, wherein the citrus plant is injected in the scion.

A seventieth embodiment relates to a method of any one of embodiments 61-69, wherein the citrus plant is injected with 60, 70, 80, 90, 100, 110, or 120 mL of injection formulation.

A seventy first embodiment relates to a method of any one of embodiments 61-69, wherein the citrus plant is injected with 120, 130, 140, 150, 160, 170, 180, 190, 200, 210, 220, 230, 240, 250 mL of injection formulation.

A seventy second embodiment relates to a method of embodiment 57, wherein the rootstock is injected with an injection tool that reaches but does not exceed a depth of 8.5 to 9 mm.

A seventy third embodiment relates to a method of embodiment 58, wherein the scion is injected with an injection tool that reaches but does not exceed a depth of 8.5 to 9 mm.

A seventy fourth embodiment relates to a method of any one of embodiments 61 to 73, wherein, after injection, the citrus plant has at least about 5%, at least about 10%, or at least about 15%, or between about 10% and about 25% reduced fruit drop as compared to an untreated citrus plant.

A seventy fifth embodiment relates to a method of any one of embodiments 61 to 73, wherein, after injection, the citrus plant produces fruit with at least about 1%, at least about 2%, at least about 3%, at least about 4%, or at least about 5%, between about 5% and about 10% increased Brix as compared to an untreated citrus plant.

A seventy sixth embodiment relates to a method of any one of embodiments 61 to 73, wherein, after injection, the citrus plant has at least about 10%, at least about 20%, at least about 30%, at least about 40%, or at least about 50%, or between about 40% and about 75% increased fruit yield as compared to an untreated citrus plant.

A seventy seventh embodiment relates to a method of any one of embodiments 61 to 76, wherein the citrus plant is injected 150-120 days prior to harvest.

A seventy eighth embodiment relates to a method of treating citrus greening and leaf mottling in citrus plant with a scion diameter of about 2 cm to about 6 cm, wherein the citrus plant has an active vasculature that runs through the trunk or stem to other parts of the citrus plant, the method comprising: injecting an injection formulation comprising oxytetracycline (OTC) or a salt thereof into the active vasculature of the citrus plant, wherein the injection formulation is injected into the citrus plant one or more times a growing season to reduce citrus greening.

A seventy nineth embodiment relates to a method of embodiment 78, wherein the citrus plant is injected once with an injection formulation comprising 75 mg oxytetracycline hydrochloride.

An eightieth embodiment relates to a method of embodiment 78, wherein the citrus plant is injected two times with an injection formulation comprising 37.5 mg oxytetracycline hydrochloride.

An eighty first embodiment relates to a method of embodiment 78, wherein the citrus plant is injected three times with an injection formulation comprising 25 mg oxytetracycline hydrochloride.

An eighty second embodiment relates to a method of any one of embodiments 80 and 81, wherein the injections are spaced about 30 days apart.

An eighty third embodiment relates to a method of any one of embodiments 80 and 81, wherein the injections are spaced about 45 days apart.

An eighty fourth embodiment relates to a method of any one of embodiments 80 and 81, wherein the injections are spaced about 60 days apart.

An eighty fifth embodiment relates to a method of any one of embodiments 78-85, wherein the citrus plant is injected in rootstock.

An eighty sixth embodiment relates to a method of any one of embodiments 78-85, wherein the citrus plant is injected in the scion.

An eighty seventh embodiment relates to a method of embodiment 85, wherein the rootstock is injected with a with an injection tool that reaches but does not exceed a depth of 6.5 mm.

An eighty eighth embodiment relates to a method of embodiment 86, wherein the scion is injected with a with an injection tool that reaches but does not exceed a depth of 6.5 mm.

An eighty-nineth embodiment relates to a method of any one of embodiments 78-88, wherein the citrus plant is injected with 20, 30, 40, 50, 60, 70, 80, 90, 100, 110, or 120 mL of injection formulation.

A ninetieth embodiment relates to a method of any one of embodiments 78 to 89, wherein, after injection, the citrus plant has at least about 5%, at least about 10%, or at least about 15%, or between about 10% and about 25% reduced leaf mottling as compared to an untreated citrus plant.

### EXAMPLES

The presently disclosed subject matter will be better understood by reference to the following Examples, which are provided as exemplary of the invention, and not by way of limitation.

### Example 1: Field Trial

This example demonstrates the effect of oxytetracycline (OTC) on treating citrus greening in orange trees.

Field trial design. A field trial was initiated on March 30 by applying treatments to commercial orange trees that have a Hamlin variety scion grafted onto an X639 variety rootstock. Treatments included the application of oxytetracycline (OTC) using Invaio's proprietary injection system into the scion of each tree. The trial was designed as a randomized complete blocking which three treatments were applied to each of four trees within each of six replications at three different treatment dates. A full list of treatments is included in Table 1. The OTC is a commercial oxytetracycline product. All injections were made at a rate of 60 ml at the concentration shown in Table 1. One injection of OTC was made in each tree for the first two injections timings and two OTC injections were made per tree at the third application timing.

TABLE 1

| Treatment | | Concentration | Injections per tree per |
|---|---|---|---|
| date | Treatment | (mg/mL) | application |
| 30-Mar | OTC | 1.58 | 1 |
| 30-Mar | Nontreated | n/a | n/a |
| 15-Jun | OTC | 1.58 | 1 |
| 15-Jun | Nontreated | n/a | n/a |
| 5-Oct | OTC | 1.58 | 2 |
| 5-Oct | Nontreated | n/a | n/a |

BRIX analysis. Fruit was collected from trees of each treatment by replication on December 8 and bulked according to treatment and replication to create individual fruit samples for BRIX analysis. On average, trees injected with OTC had higher BRIX than nontreated trees (Table 2). The range in BRIX for nontreated trees across replications was 7.1 to 7.7 and the range in BRIX for OTC treated trees across replications was 7.6 to 8.4.

TABLE 2

| | Treatment | Replication | Brix |
|---|---|---|---|
| | Nontreated | 1 | 7.7 |
| | Nontreated | 2 | 7.5 |
| | Nontreated | 3 | 7.4 |
| | Nontreated | 4 | 7.1 |
| | Nontreated | 5 | 7.5 |
| | Nontreated | 6 | 7.5 |
| Treatment average | | | 7.5 |
| | OTC | 1 | 8.1 |
| | OTC | 2 | 8.4 |
| | OTC | 3 | 8.1 |
| | OTC | 4 | 8 |
| | OTC | 5 | 7.6 |
| | OTC | 6 | 7.6 |

| | |
|---|---|
| Treatment average | 8.0 |

Fruit yield. Fruit yield was determined for trees of each treatment as the total weight (lbs) of fruit picked (harvested) from each tree on December 21. Fruit yield was recorded as an average by replication and as an average across all six replications (Table 3). The average fruit yield from each tree of each treatment was 48.7 lbs for the OTC treatment, and 32.0 lbs for the nontreated treatment. The range in average fruit yield across replications for nontreated trees was 23.1 to 45.2 lbs per tree and the range in average fruit yield across replications for OTC treated trees was 37.4 to 81.0 lbs per tree.

TABLE 3

| | Treatment | Replication | Fruit yield (lbs per tree) |
|---|---|---|---|
| | OTC | 1 | 43.7 |
| | OTC | 2 | 81.0 |
| | OTC | 3 | 41.6 |
| | OTC | 4 | 50.3 |
| | OTC | 5 | 37.4 |
| | OTC | 6 | 48.7 |
| Treatment average | | | 50.4 |
| | Nontreated | 1 | 27.4 |
| | Nontreated | 2 | 32.9 |
| | Nontreated | 3 | 45.2 |
| | Nontreated | 4 | 23.1 |
| | Nontreated | 5 | 28.1 |
| | Nontreated | 6 | 35.7 |

| | |
|---|---|
| Treatment average | 32.0 |

Fruit drop. Fruit drop was determined for trees of each treatment as the number of fruit on the ground underneath each tree at each of six counting dates, approximately 2 weeks apart, beginning on October 13 and finishing prior to fruit harvest on December 21. Counted fruit were removed from the ground after each counting date. Fruit drop was recorded as an average by date and as an average across all six dates (Table 4). The average number of fruit dropped from trees of each treatment were 17.8 for the OTC treatment, and 22.0 for the nontreated treatment. The range in average fruit drop across replications for nontreated trees was 20.5 to 25.3 and the range in average fruit drop across replications for OTC treated trees was 14.5 to 20.9.

TABLE 4

| | | Counting | Fruit drop | | | Counting | Fruit drop |
|---|---|---|---|---|---|---|---|
| Treatment | Replication | date | (number) | Treatment | Replication | date | (number) |
| OTC | 1 | 13-Oct | 14.3 | Nontreated | 1 | 13-Oct | 18.8 |
| OTC | 1 | 28-Oct | 15.0 | Nontreated | 1 | 28-Oct | 12.3 |
| OTC | 1 | 9-Nov | 28.0 | Nontreated | 1 | 9-Nov | 36.8 |
| OTC | 1 | 24-Nov | 28.0 | Nontreated | 1 | 24-Nov | 35.5 |
| OTC | 1 | 8-Dec | 22.8 | Nontreated | 1 | 8-Dec | 25.5 |
| OTC | 1 | 21-Dec | 17.5 | Nontreated | 1 | 21-Dec | 23.0 |
| Rep average across dates | | | 20.9 | Rep average across dates | | | 25.3 |
| OTC | 2 | 13-Oct | 11.5 | Nontreated | 2 | 13-Oct | 6.8 |
| OTC | 2 | 28-Oct | 14.5 | Nontreated | 2 | 28-Oct | 15.5 |
| OTC | 2 | 9-Nov | 31.5 | Nontreated | 2 | 9-Nov | 29.5 |
| OTC | 2 | 24-Nov | 26.8 | Nontreated | 2 | 24-Nov | 21.8 |
| OTC | 2 | 8-Dec | 19.0 | Nontreated | 2 | 8-Dec | 23.3 |
| OTC | 2 | 21-Dec | 20.0 | Nontreated | 2 | 21-Dec | 26.8 |
| Rep average across dates | | | 20.5 | Rep average across dates | | | 20.6 |
| OTC | 3 | 13-Oct | 8.8 | Nontreated | 3 | 13-Oct | 11.0 |
| OTC | 3 | 28-Oct | 18.8 | Nontreated | 3 | 28-Oct | 18.8 |
| OTC | 3 | 9-Nov | 20.5 | Nontreated | 3 | 9-Nov | 34.8 |
| OTC | 3 | 24-Nov | 18.3 | Nontreated | 3 | 24-Nov | 18.8 |
| OTC | 3 | 8-Dec | 13.3 | Nontreated | 3 | 8-Dec | 20.0 |
| OTC | 3 | 21-Dec | 16.5 | Nontreated | 3 | 21-Dec | 32.0 |
| Rep average across dates | | | 16.0 | Rep average across dates | | | 22.5 |
| OTC | 4 | 13-Oct | 9.0 | Nontreated | 4 | 13-Oct | 18.0 |
| OTC | 4 | 28-Oct | 18.3 | Nontreated | 4 | 28-OTC | 24.0 |
| OTC | 4 | 9-Nov | 23.8 | Nontreated | 4 | 9-Nov | 29.8 |
| OTC | 4 | 24-Nov | 20.8 | Nontreated | 4 | 24-Nov | 29.0 |
| OTC | 4 | 8-Dec | 14.0 | Nontreated | 4 | 8-Dec | 13.5 |
| OTC | 4 | 21-Dec | 16.8 | Nontreated | 4 | 21-Dec | 18.0 |
| Rep average across dates | | | 17.1 | Rep average across dates | | | 22.0 |
| OTC | 5 | 13-Oct | 7.3 | Nontreated | 5 | 13-Oct | 12.5 |
| OTC | 5 | 28-Oct | 16.3 | Nontreated | 5 | 28-Oct | 19.0 |
| OTC | 5 | 9-Nov | 18.5 | Nontreated | 5 | 9-Nov | 27.5 |
| OTC | 5 | 24-Nov | 20.8 | Nontreated | 5 | 24-Nov | 27.8 |
| OTC | 5 | 8-Dec | 12.3 | Nontreated | 5 | 8-Dec | 20.0 |
| OTC | 5 | 21-Dec | 12.0 | Nontreated | 5 | 21-Dec | 16.0 |
| Rep average across dates | | | 14.5 | Rep average across dates | | | 20.5 |
| OTC | 6 | 13-Oct | 14.5 | Nontreated | 6 | 13-Oct | 19.0 |
| OTC | 6 | 28-Oct | 19.8 | Nontreated | 6 | 28-Oct | 20.8 |
| OTC | 6 | 9-Nov | 22.0 | Nontreated | 6 | 9-Nov | 29.8 |
| OTC | 6 | 24-Nov | 21.8 | Nontreated | 6 | 24-Nov | 27.5 |
| OTC | 6 | 8-Dec | 15.0 | Nontreated | 6 | 8-Dec | 15.5 |
| OTC | 6 | 21-Dec | 15.0 | Nontreated | 6 | 21-Dec | 18.3 |

| | | | |
|---|---|---|---|
| Rep average across dates | 18.0 | Rep average across dates | 21.8 |
| Treatment average | 17.8 | Treatment average | 22.1 |

Residue analysis. Fruit was collected from trees of the OTC treatment by replication on December 7 and bulked according to treatment and replication to create individual fruit samples for OTC residue analysis. Similarly, fruit was collected from trees from two replications of nontreated treatments and bulked by replication to create individual fruit samples for OTC residue analysis. No OTC residue was detected on fruit harvested from the nontreated trees. OTC residue detected in fruit bulked from trees treated with OTC were all below the established minimum residue limit of 0.01 ppm. On average, trees injected with OTC had a residue detected of 0.007 ppm with a range of 0.002 ppm to 0.009 ppm across replications (Table 5).

TABLE 5

| | Treatment | Replication | Average Concentration (ppm) |
|---|---|---|---|
| | OTC | 1 | 0.006666 |
| | OTC | 2 | 0.002633 |
| | OTC | 3 | 0.008066 |
| | OTC | 4 | 0.006366 |
| | OTC | 5 | 0.006533 |
| | OTC | 6 | 0.009433 |
| Treatment average | | | 0.006616167 |
| | Nontreated | 1 | 0 |
| | Nontreated | 2 | 0 |

| | |
|---|---|
| Treatment average | 0 |

### Example 2: Field Trial—Two-Season, Single Location Study

This example demonstrates that the use of ArborBiotic™ (a systemic water-soluble injectable antibiotic for the control of certain bacterial diseases, MGF Scientific) in combination with an exemplary injection system as described herein can effectively improve the fruit yield and juice quality of orange trees.

Field Trial Design. A field trial study was conducted over two growing seasons by applying treatments to commercial orange trees that have a Hamlin variety scion grafted onto an X639 variety rootstock. The field trial was designed to evaluate the effect of using a commercial water-soluble, injectable formulation containing oxytetracycline hydrochloride (OTC-HCl), applied using the exemplary injection systems described herein on yield components and juice quality of orange trees as a potential solution for overcoming the negative impacts of HLB on fruit yield and juice quality. The composition of the injection formulation is reported in Table 6. The injection formulation used is ArborBiotic™ and is currently approved for trunk injection in non-fruit bearing trees including Citrus against a range of diseases but not including HLB (Citrus Greening).

TABLE 6
Composition of Injection Formulation

| Ingredient | Quantity (%) |
|---|---|
| Oxytetracycline hydrochloride^{a} | 39.6 |
| Other ingredients | 60.4 |
| Total | 100.0 |

^{a}equivalent to 36.7% oxytetracycline

The field trial was designed as a randomized complete block with six blocks (replications) of two treatments (12 plots). Of the 12 plots, 6 plots were treated with the injection formulation and 6 plots were treated with water (negative control). The plots were large enough to ensure sufficient quantity of representative specimens and sufficient quantity of material could be provided for residue analysis. Each plot was represented by four trees and treatments were applied during two growing seasons. Each tree was clearly identified, with a unique identification number. Due to the application method a larger buffer between water treated plots and the OTC treated plots was not required. No other formulations containing OTC were applied to the trees during the trial period.

Treatments. The number and timing of applications varied by season but the quantity of OTC-HCl (150 mg) delivered to each tree during both seasons remained the same. A full list of treatments during season 1 and season 2 is included in Table 7.

TABLE 7
Treatments

| | | | | Injections | | | Total |
|---|---|---|---|---|---|---|---|
| | Treatment | Active | Application | per tree per | Concentration | OTC-HCl | OTC-HCl |
| # | Date | applied | location | application | (mg/ml) | (mg/ml) | (mg/injection) |
| — | 30-Mar | Nontreated | n/a | n/a | n/a | n/a | n/a |
| 1 | | ArborBiotic ™ | Scion | 2 | 1.58 | 0.625 | 37.5 |
| — | 15-Jun | Nontreated | n/a | n/a | n/a | n/a | n/a |
| 2 | | ArborBiotic ™ | Scion | 2 | 1.58 | 0.625 | 37.5 |
| — | 5-Oct | Nontreated | n/a | n/a | n/a | n/a | n/a |
| 3 | | ArborBiotic ™ | Scion | 1 | 1.58 | 0.625 | 75.0 |
| 4 | 8-Mar | Water | Rootstock | 2 | n/a | n/a | n/a |
| 5 | | ArborBiotic ™ | Rootstock | 2 | 1.58 | 0.625 | 75.0 |
| 6 | 14-Jun | Water | Rootstock | 2 | n/a | n/a | n/a |
| 7 | | ArborBiotic ™ | Rootstock | 2 | 1.58 | 0.625 | 75.0 |

During season 1, treatments included a non-injected water control (nontreated) and injection of the OTC formulation into the scion of Hamlin orange trees. Season 1 treatments are described as treatment numbers 1-3 in Table 7. Each tree in the treated plots received two applications of the OTC formulation 73 days apart. The application comprised either one or two injections. For treatment numbers 1 and 2, each application included two injections of 94.8 mg of the OTC formulation in 60 ml of distilled water, which delivered a dose of 37.5 mg OTC-HCl per injection per tree. For treatment number 3, each application comprised one injection of 189.6 mg of the OTC formulation in 120 ml of distilled water, which delivered a dose of 75.1 mg OTC-HCl per injection per tree. Each tree treated with the OTC formulation received a total of 379.2 mg of the OTC formulation during season 1, which is equivalent to 150.1 mg of OTC-HCl.

During season 2,treatments included injection of water into the Hamlin orange trees that were not treated during season 1 and injection of the OTC formulation into the Hamlin orange trees that received treatment with the OTC formulation during season 1. Season 2 treatments are described as treatment numbers 4-7 in Table 7. During season 2, each tree in the treated plots received two applications during the season and the treatments were injected into the rootstock of the tree. For treatment numbers 4 and 6, which include water as the negative control, each application included two injections of 60 ml of distilled water per tree for a total volume of 120 mL per application, with applications 3-5 months apart. For treatment numbers 5 and 6, each application included one injections of 189.6 mg of the OTC formulation in 120 ml of distilled water, which delivered a dose of 75.1 mg OTC-HCl per injection per tree, with applications 94 days apart. Each tree treated with the OTC formulation received a total of 379.2 mg of the OTC formulation during season 2, which is equivalent to 150.1 mg of OTC-HCl.

Application Method. The application method of the treatments was tree trunk injections using an exemplary injection system as described herein. The application vehicle was bottled deionized water. Each container initially contained 60 ml of an aqueous solution of the OTC formulation. The solution was prepared on or one day prior to the day of application, and each application container was uniquely identified. The volume remaining in the container 7 days after application indicated uptake by the tree. The injection system was removed from the tree 7-8 days after application.

Analysis. Treatment efficacy was determined based on evaluation of different yield components, including harvest weight, fruit number, percent dropped fruit (total during the two months prior to harvest), and fruit size (weight per fruit), as well as different juice quality parameters including Brix content, acid content, and Brix/acid ratio. Analysis of Variance (ANOVA) was used to analyze data collected.

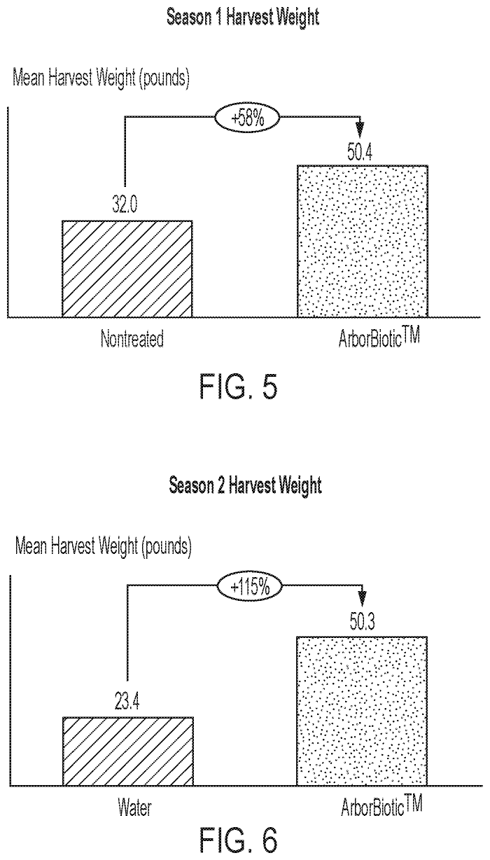

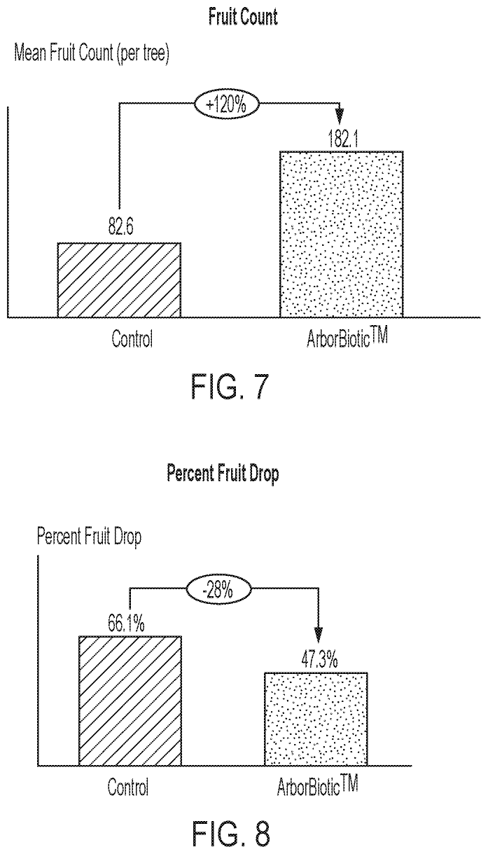

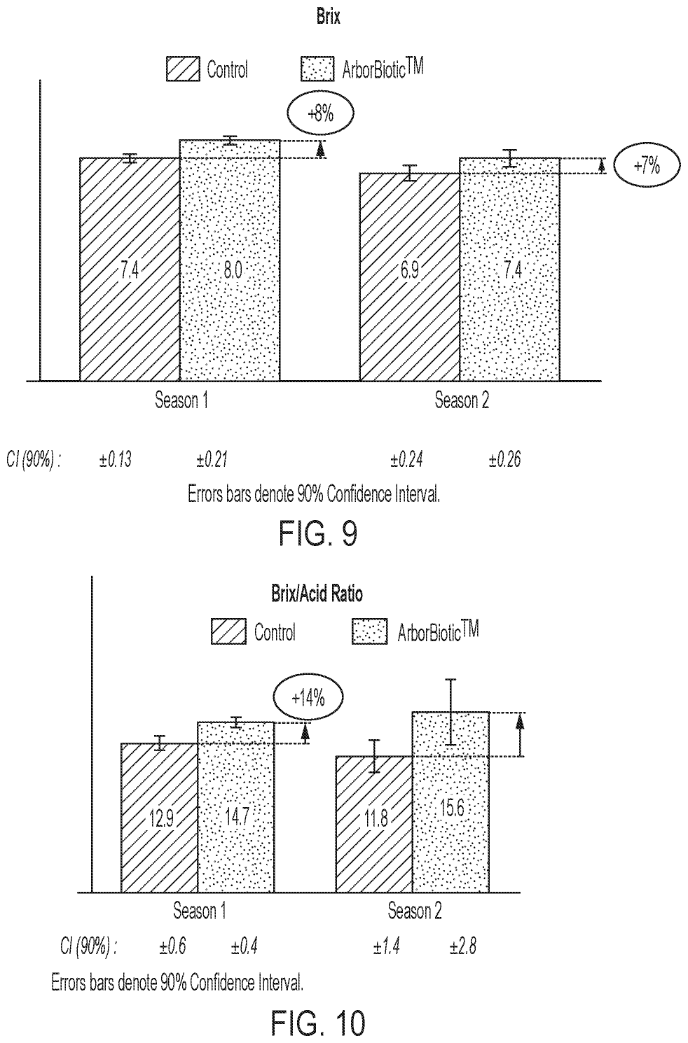

Results. In seasons 1 and 2, the OTC formulation treated plots averaged about 58% (FIG. 5) and about 115% (FIG. 6), respectively more harvest fruit weight than the controls, and, over two years, the OTC treatment averaged about 82% more harvest fruit weight than the controls (data not shown in graphs). The increase in yield was due to an increase in fruit count and a decrease in fruit drop. In season 2, the OTC treated plots averaged about 120% more fruit than control plots (FIG.7). Fruit count data was not collected in season 1. In season 2, the OTC treated plots averaged about 28% less fruit drop than the control plots (FIG. 8). A summary of the results of the analysis is reported in Table 8.

TABLE 8
Summary of Results

| | Efficacy | Treatment |
|---|---|---|
| ArborBiotic ™ Treatment | Variable | Effect Direction |
| Season 1, Season 2 | Harvest fruit weight | Increase |
| Season 2 | Fruit count | Increase |
| Season 2 | Percent fruit drop | Decrease |
| Season 1, Season 2 | Brix | Increase |
| Season 1, Season 2 | Acid | Decrease |
| Season 1, Season 2 | Brix/acid ratio | Increase |

### Conclusions

Efficacy of the OTC injections against HLB has been determined using measurements of yield components (harvest fruit weight, fruit count, fruit size, and % fruit drop) and juice quality (Brix content, acid content, Brix/acid ratio). These are the most economically significant and quantifiably consistent and accurate indications of the OTC formulation performance on orange trees infected with Clas and showing symptoms of Citrus greening.

The data and statistical analysis from the field study show that mean harvest fruit weight (weight of harvested fruit) from trees treated with 150 mg OTC-HCl were significantly higher yielding than a non-treated control in season 1 and a water control in season 2. In fact, the OTC treated plots averaged 57.4% and 115.3% more harvest weight than the controls in seasons 1 and 2, respectively. The increase in yield improvement suggests that continuing injections of the OTC formulation over time can have a cumulative effect on harvest fruit weight.

Additional data relative to yield were collected during season 2, including fruit count (number of fruit on the tree at harvest), fruit size (weight of individual fruit at harvest), and percent of total fruit that dropped within a period beginning two months prior to and up to harvest. These results provide insight into which yield components are contributing to the increase in harvest weight. Trees injected with 150 mg OTC-HCl of the OTC formulation significantly increased fruit count (120% increase in season 2) and significantly reduced percent fruit drop (39% less in season 2) relative to the water treatment (negative control). The OTC formulation did not affect fruit size as fruit from ArborBiotic™ treatments and from the water treatment both averaged 0.28 lb/fruit.

Fruit harvested from trees was evaluated for juice quality, including Brix content and Acid content. The data from these evaluations show that fruit harvested from trees treated with the OTC formulation in seasons 1 and 2 had Brix content 8.1% and 7.2%, respectively, higher than trees of the controls, acid content in season 1 and season 2 that was 6.9% and 16.7%, respectively, lower than trees of the controls, and Brix/Acid ratios 14% and 32%, respectively, higher than trees of the controls. Thus, OTC injections not only improved the amount of fruit harvested but it improved the quality of the juice from that fruit.

### Example 3: Field Trial—Environment, Concentration, and Application Rate Study

This example demonstrates that one or more injections of the OTC formulation, ArborBiotic™, using an exemplary injection system as described herein provides statistically significant improvements to orange fruit yield across a range of environments, concentrations and application rates over a water injected control and a foliar-applied commercial OTC product.

Field Trial Design. A field trial study was conducted by applying various treatments to commercial orange trees in different citrus growing regions during one growing season. The field trial was designed to develop the most effective use patterns (e.g., concentrations and injection rates) for the use of the OTC formulation applied using an exemplary injection system as described herein by treating different varieties of orange trees located in different environments. The study included eight locations (01-08), and contained both short season (Hamlin) and long season varieties (Valencia, OLL8) of orange trees, and the trial locations are representative of commercial citrus growing areas.

Treatments included the application of ArborBiotic™ (a commercial oxytetracycline hydrochloride or “OTC-HCl” containing product), water as a negative control, and FireLine™ 17 WP (a commercially available OTC-HCl containing product manufactured by AgroSource) as a positive control and commercial reference. ArborBiotic™ and water treatments were injected using an exemplary injection system as described herein, and FireLine™ 17 WP was foliar-applied (i.e., sprayed). The composition of ArborBiotic™ and FireLine™ 17 WP are reported in Table 9.

TABLE 9
Composition of ArborBiotic ™ and FireLine ™ 17 WP

| ArborBiotic | | FireLine ™ 17 WP | |
|---|---|---|---|
| Ingredient | Quantity (%) | Ingredient | Quantity (%) |
| Oxytetracycline hydrochloride^{a} | 39.6 | Oxytetracycline hydrochloride^{b} | 18.3 |
| Other ingredients | 60.4 | Related ingredients | 0.17 |
| Total | 100.0 | Other ingredients | 81.53 |
| | | Total | 100.0 |

^{a}equivalent to 36.7% oxytetracycline
^{b}equivalent to 17.0% oxytetracycline

The field trial was designed as a randomized complete block with six blocks (replications) of six treatments (36 plots) and was repeated at each of location. Each plot was represented by two trees. Of the 36 plots, 6 plots were treated with Treatment 1 (T1), 6 plots were treated with Treatment 2 (T2), 6 plots were treated with Treatment 3 (T3), 6 plots were treated with Treatment 4 (T4), 6 plots were treated with FireLine™ 17 WP Spray as a positive control and a commercial reference, and 6 plots were treated with water as a negative control. Each tree in the treated plots received either one or two injections (depending on treatments) per application timing, with one or two applications per year.

All treatments used are summarized in Table 10. Treatments were injected into the trunk of the orange trees. Treatment applications occurred either once or twice during the growing season. For treatment 1(T1), each application included one injection of 94.8 mg ArborBiotic™ in 60 mL of distilled water, which delivered a dose of 37.5 mg of OTC-HCl per injection per tree. For treatment 2 (T2), each application included two injections of 94.8 mg ArborBiotic™ in 60 mL of distilled water (for a total of 189.6 mg of ArborBiotic™ and 120 mL of distilled water), which delivered a total dose of 75.1 mg of OTC-HCl per application per tree. For treatment 3 (T3), each application included one injection of 189.0 mg ArborBiotic™ in 60 mL of distilled water, which delivered a total dose of 74.8 mg of OTC-HCl per application per tree. Treatment 4 (T4) was applied in a single application comprising two injections of 189.0 mg ArborBiotic™ in 60 mL of distilled water (for a total of 378.0 mg of ArborBiotic™ and 120 mL of distilled water), which delivered a total dose of 149.7 mg of OTC-HCl.

TABLE 10
Treatments

| | | | | Number of | Volume/ | Total OTC- | Total OTC- |
|---|---|---|---|---|---|---|---|
| | Active | Product | OTC-HCl | applications/ | application/ | HCl (mg/ | HCl (mg/ |
| Treatment | ingredient | (mg/ml) | (mg/ml)* | season | tree (ml) | application) | season) |
| Water | Water | n/a | n/a | 2 | 120 | n/a | n/a |
| T1 | ArborBiotic ™ | 1.58 | 0.625 | 2 | 60 | 37.5 | 75 |
| T2 | ArborBiotic ™ | 1.58 | 0.625 | 2 | 120 | 75 | 150 |
| T3 | ArborBiotic ™ | 3.15 | 1.25 | 2 | 60 | 75 | 150 |
| T4 | ArborBiotic ™ | 3.15 | 1.25 | 1 | 120 | 150 | 150 |
| FireLine ™ | FireLine ™* | | 0.33 | 2 | 1890 | n/a | 625 |
| Spray | | | | | | | |

*FireLine values are estimates based on label application rates and approximate number of trees per acre.

Application timings varied by location due to variety maturity differences across locations; time between the first and second application, for trees receiving more than one application, was 3 to 5 months. For example, the first applications were made as soon as possible after the final harvest from the previous season, and the second applications were made no less than 60 days after the first application and no later than 120 days prior to harvest (treatment occurred 119 days prior to a premature harvest for one location). Late season orange varieties received injections in May and October, short season orange varieties received injections in March or April and June or August. The foliar applications of FireLine™ 17 WP coincided with injection applications of other treatments and were done using a backpack sprayer at the label rate of 24 oz. per acre.

The plots were large enough to ensure sufficient quantity of representative specimens and sufficient quantity of material can be provided for residue analysis. The plots treated with water (negative control) had 2 trees, the plots treated with ArborBiotic™ (T1, T2, T3, and T4) and FireLine™ had 2 trees (a total of 12 trees per treatment). Each tree was clearly identified, with a unique number (such as Experiment No., Plot No., and Tree No.). At least 1 buffer tree between the FireLine™ 17 WP Spray treated and all other treated trees was maintained. Each plot within a location contained the same orange variety (scion and rootstock genotype), but variety differed by location. Due to the application method a larger buffer between water and plots treated with ArborBiotic™ was not required. No other formulations containing OTC-HCl were applied during the trial period.

Application Method. The application method was tree trunk injections using an exemplary injection system as described herein. The application vehicle was bottled deionized water. The application solution was prepared on or one day prior to the day of application. Each application container was uniquely identified. Each container initially contained 60 ml of an aqueous solution of ArborBiotic™. The volume remaining in the container 7 days after application indicated uptake by the tree. The injection system was removed from the tree 7-8 days after application.

Analysis. Treatment efficacy was determined based on evaluation of different yield components, including harvest weight, fruit number, percent dropped fruit (total during the two months prior to harvest), and fruit size (weight per fruit), as well as different juice quality parameters including Brix content, acid content, and Brix/acid ratio.

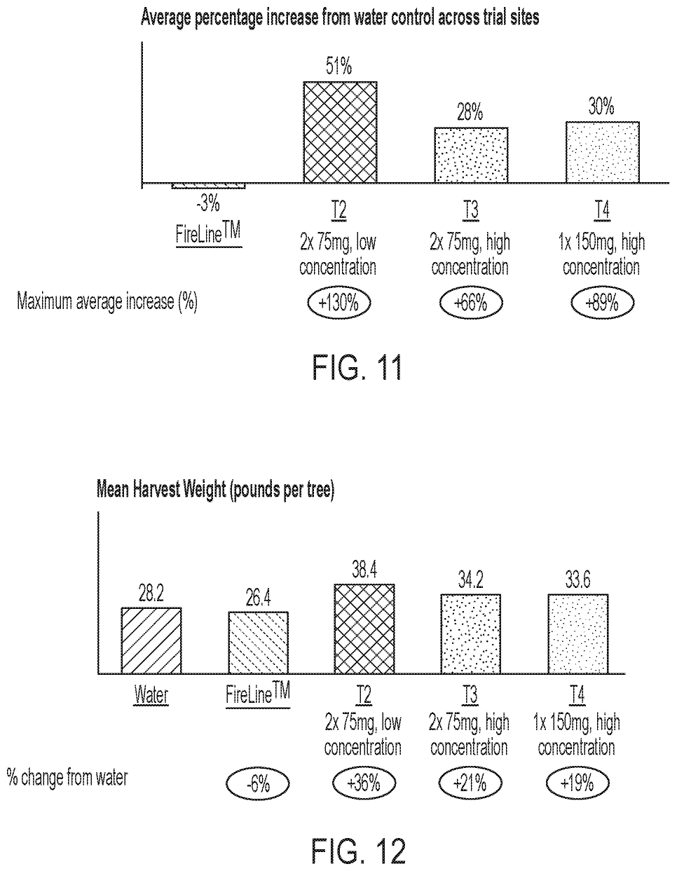

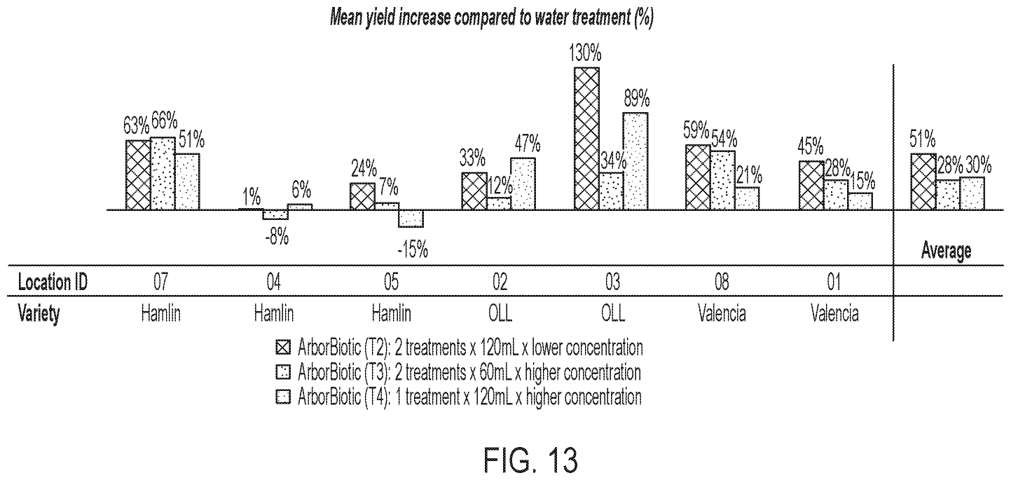

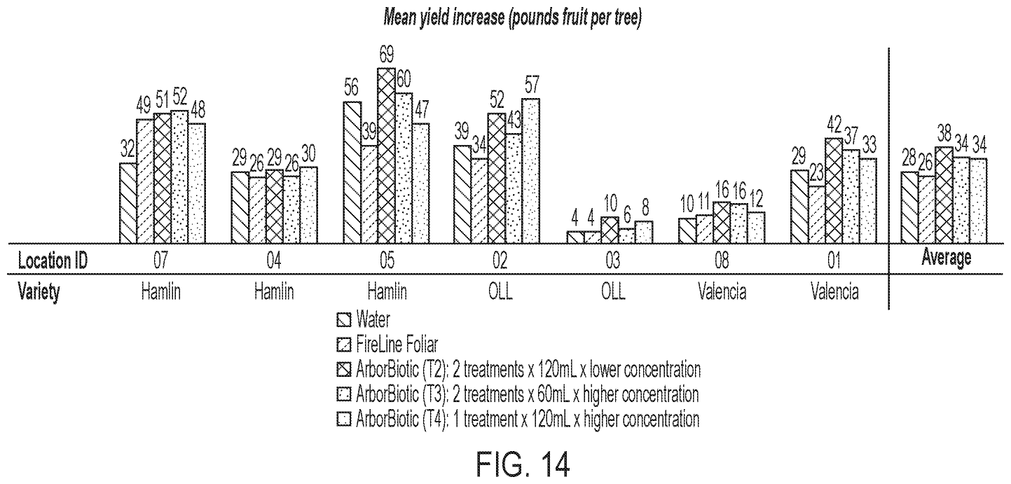

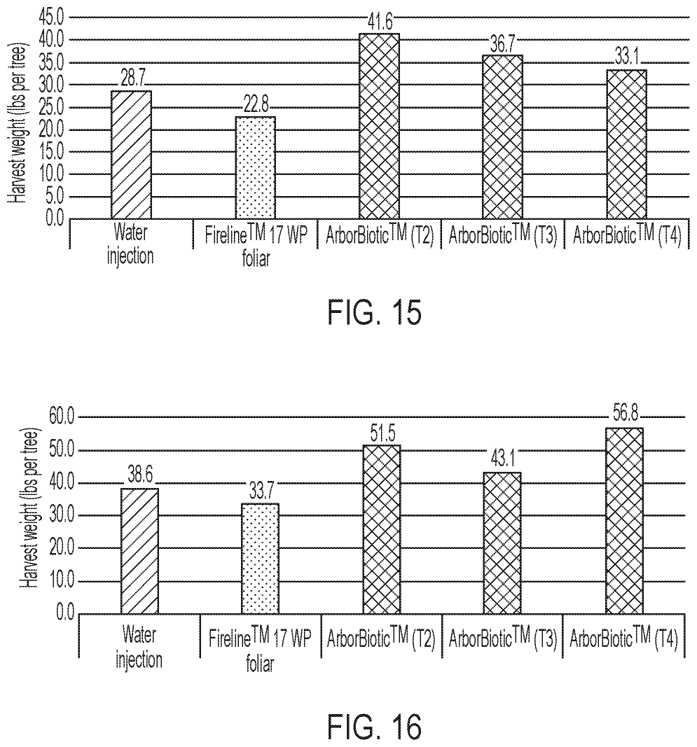

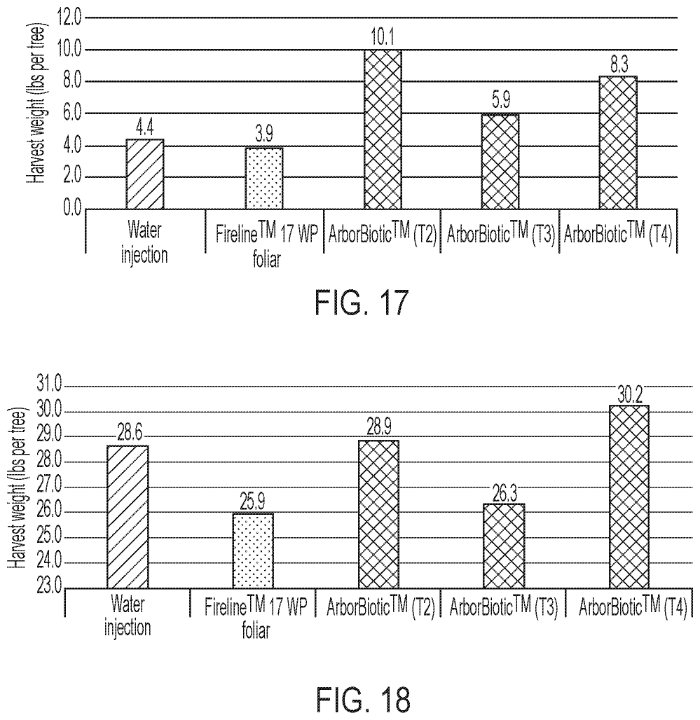

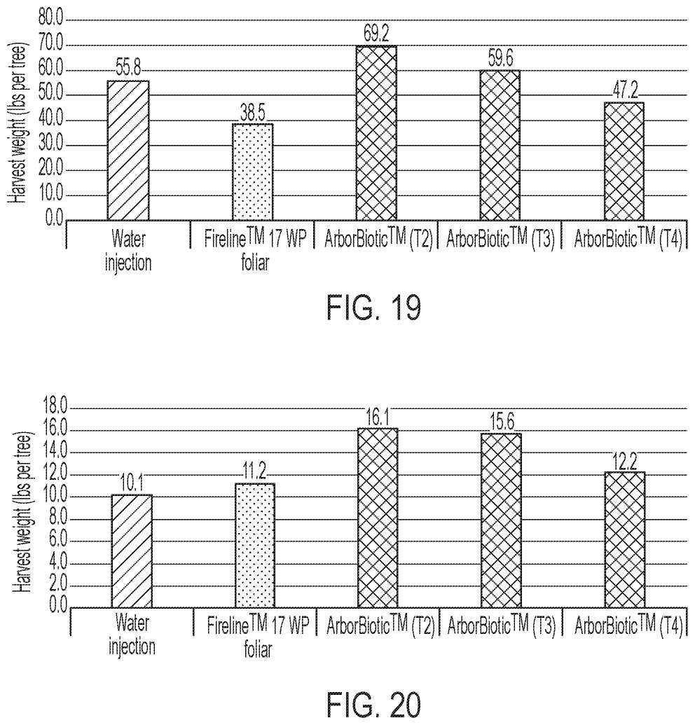

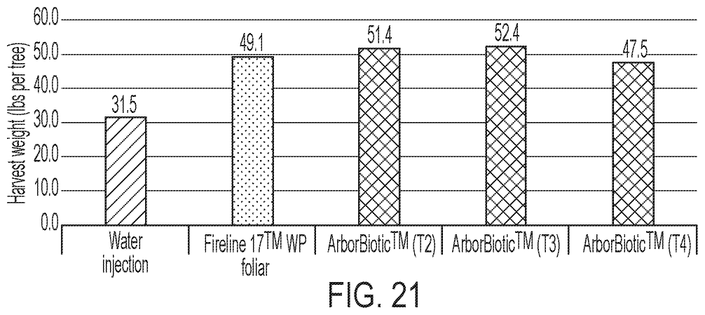

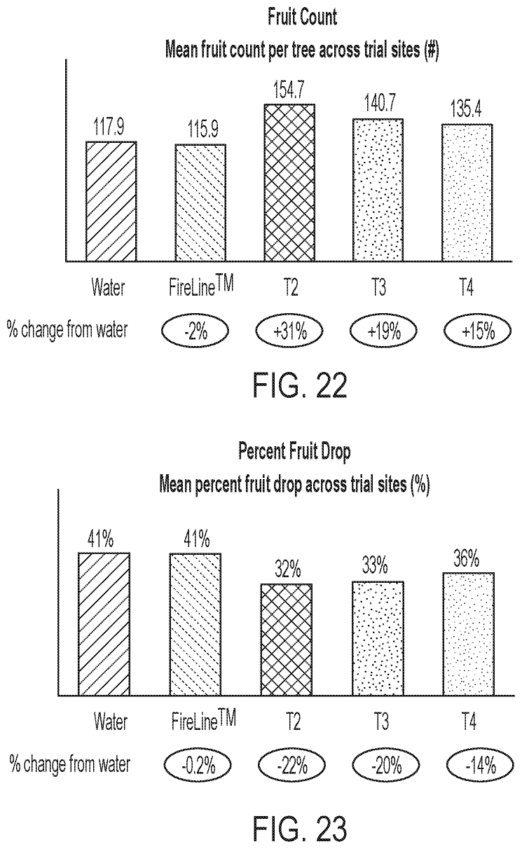

Results. An average of about 28% to 51% yield increase was observed after one season of treatment with ArborBiotic™ treatment compared to the control, and up to about 130% yield increase in some sites (FIG. 11). The increase in yield was due to an increase in fruit count and a decrease in fruit drop, discussed below. The mean harvest weight (in pounds per tree) for the various treatments is reported in FIG. 12. A variation in mean yield increase for trees treated with ArborBiotic™ (T2, T3, T4) as compared to treatment with water was observed across locations (FIGS. 13 and 14). The harvest weight as measured in pounds per tree for trees treated with ArborBiotic™ (T2, T3, T4) as compared to treatment with water and FireLine™ 17 WP foliar spray for various locations. See FIGS. 15-21. The mean fruit count per tree across trial sites for treatments with water, FireLine™, and treatments T1, T2, T3, and T4, and the percent increase change from water is reported in FIG. 22. The mean percent fruit drop across trial sites for the treatments with water, FireLine™, and treatments T2, T3, and T4 is reported in FIG. 23. On average, these ArborBiotic™ treatments had 18.6% less drop than water and 18.4% less drop than FireLine™ 17 WP Spray.

### Conclusions

The results from the field study showed that all ArborBiotic™ treatments (in location IDs 01, 02, 04, 05, and 07), regardless of OTC-HCl concentration (0.625 mg/ml v. 1.25 mg/ml), injection rate (120 ml v. 240 ml), and mg of OTC-HCl injected over the season (75 mg v. 150 mg), increased mean harvest fruit weight as compared to injections of a water treatment (negative control) and foliar applications of FireLine™. On average, ArborBiotic™ treatments had higher harvest fruit weight relative to water by 19.6% (9.8% to 32.3% across ArborBiotic™ treatments) and higher harvest fruit weight relative to FireLine™ by 28.9% (18.4% to 42.6% across ArborBiotic™ treatments). These results confirm the results from Example 2 and demonstrate the versatility growers have for injecting OTC-HCl in the form of ArborBiotic™ into orange trees to realize improvements in harvest fruit weight. These results also demonstrate that foliar applications of OTC-HCl in the form of FireLine™ are not effective as they offer no measurable improvement over the nontreated negative control.

Additional data relative to yield were collected, including fruit count (number of fruit on the tree at harvest), fruit size (weight of individual fruit at harvest), and percent of total fruit that dropped within a period beginning two months prior to harvest. The analyses of these data support the conclusion that an increase in fruit count and decrease in percent fruit drop are the major contributors to the increase in harvest weight. Across ArborBiotic™ treatments, injected trees had higher fruit counts than water injections by 11.9% to 31.2% (19.3% average across ArborBioticTM treatments) and higher fruit counts than FireLine™ by 13.8% to 33.5% (21.4% average across ArborBiotic™ treatments). For percent fruit drop, ArborBiotic™ treatments had 15.7% less fruit drop than water (7.2% to 21.7% less across ArborBiotic™ treatments) and 15.5% less drop than FireLine™ (7.0% to 21.5% less across ArborBiotic™ treatments). Mean fruit size had little impact on harvest weight as lb/fruit for ArborBiotic™, Water, and FireLine™ treatments averaged 0.32, 0.32, and 0.30 respectively.

The analysis of juice quality from fruit harvested from trees in location IDs 01, 02, 04, 05, and 07 showed nonsignificant impacts of ArborBiotic™ injections on Brix content, acid content, or Brix/acid ratio over Water injections and FireLine™ foliar applications across locations. Despite the lack of significance after one season of injections, the average Brix content and Brix/acid ratio of an ArborBiotic™ treatment delivering 150 mg OTC-HCl per season (T2) were 6.1% and 6.2% higher on average across locations, respectively, over water treatments and as high as 16.7% and 15.4% higher, respectively, at specific locations.

Treatments with OTC-Cl applied as ArborBiotic™ with the injection systems as described herein outperformed both the Fireline™ foliar treatment, which indicates that the method of application has a significant impact on the ability of the OTC-Cl treatment (and ArborBiotic™ specifically) to be so highly efficacious on orange trees.

These results indicate that one or more injections of ArborBiotic™ using an exemplary injection systems as described herein provides statistically significant improvements to orange fruit yield across a range of environments, concentrations, and application rates over a water injected control and over the labelled use of a foliar-applied commercial OTC product (FireLine™ 17 WP), which can thereby be used to effectively improve the fruit yield and juice quality of HLB infected orange trees.

### Example 4: Field Trial—Study of the Magnitude of Residues of OTC and its Metabolite in Orange Raw Agricultural Commodities and Processed Commodities

This example demonstrates that the residue levels of oxytetracycline hydrochloride (OTC-HCl) and its metabolite in or on orange processed commodities (PC) and in orange raw agricultural commodities (RACs) following injection of treatments comprising ArborBiotic™ applied to the trunk of orange trees using an exemplary injection system as described herein are compatible with current tolerance levels of OTC-HCl in citrus.

Field Trial Design. The study included eight trial sites (01-08), which contained orange trees of Hamlin, Navel or Valencia varieties. The trial sites were at least 20 miles apart and in different municipalities. If trial sites were not 20 miles apart, the sites had different varieties and application dates. Sites were chosen so that they are representative of commercial citrus growing areas, essentially weed, disease and pest free. The trial sites were chosen to avoid major sources of variation including slope, drainage or aspects that may affect disease or crop development.

Each trial site was set up identically and included 5 plots: 1 untreated control plot (“UTC”) and 4 treated plots (T1, T2, T3, T4). Plots were large enough to ensure sufficient quantity of representative specimens and sufficient quantity of material can be provided for residue analysis. Control plots had at least 4 trees and treated plots had a minimum of 8 trees. Each tree was clearly identified, with a unique number (such as Study No., Treatment No., and Tree No). At least 1 buffer tree between the treated and untreated trees was maintained. Due to the application method a larger buffer between control and treated plots was not required. No other formulations containing OTC were applied during the trial period. The test plots were not treated with products with the active ingredient OTC within the previous year. Historic records were provided for maintenance pesticide applications during the previous 3-year period. Documentation obtained for the growing seasons includes cultivation, irrigation, and maintenance pesticides applied to the test plots.

At the time of application, the air temperature, soil temperature, wind speed and direction, relative humidity, cloud cover BBCH stage, crop height, and rainfall within 24 hrs of application was recorded. During the trial period, the meteorological data, including daily min/max temperature, monthly mean daily min/max temperature, overall monthly mean temperature, and rainfall totals, were collected at the test site, and if this was not possible, at the nearest meteorological station (within 25 miles). Data were/are collected from the experimental start (start of application) until the end of the test (last sample collection).

Treatments. Treatments were injected into the trunk of the orange trees. The treatments used in the study are included in Table 11. Treatment applications occurred either once or twice during the growing season. For treatment 1 (T1), each application included one injection of 94.8 mg ArborBiotic™ in 60 mL of distilled water, which delivered a dose of 37.5 mg of OTC-HCl per injection per tree. For treatment 2 (T2), each application included two injections of 94.8 mg ArborBiotic™™ in 60 mL of distilled water (for a total of 189.6 mg of ArborBiotic™ and 120 mL of distilled water), which delivered a total dose of 75.1 mg of OTC-HCl per application per tree. For treatment 3 (T3), each application included one injection of 189.0 mg ArborBiotic™ in 60 mL of distilled water, which delivered a total dose of 74.8 mg of OTC-HCl per application per tree. Treatments T1, T2, T3 were applied twice during the season, 3 months apart. Treatment 4 (T4) was applied in a single application comprising two injections of 189.0 mg ArborBiotic™ in 60 mL of distilled water (for a total of 378.0 mg of ArborBiotic™ and 120 mL of distilled water), which delivered a total dose of 149.7 mg of OTC-HCl. Longer season varieties (e.g., Valencia) received injections in May and August, shorter season varieties (e.g., Hamlin, Navel) received injections in March and June.

TABLE 11
Treatments

| | | Total | Number of | Total OTC- | Total OTC- |
|---|---|---|---|---|---|
| | Active | ArborBiotic | applications/ | HCl (mg/ | HCl (mg/ |
| Treatment | ingredient | (mg/application) | season | injection) | season) |
| T1 | ArborBiotic ™ | 94.8 | 2 | 37.5 | 75 |
| T2 | ArborBiotic ™ | 379.2 | 2 | 75.1 | 150 |
| T3 | ArborBiotic ™ | 378.0 | 2 | 74.8 | 150 |
| T4 | ArborBiotic ™ | 378.0 | 1 | 150 | 150 |

Application Method. The application method of the treatments was tree trunk injections using an exemplary injection system as described herein. The application vehicle was bottled deionized water. The application solution was prepared on the day of application. Each container was uniquely identified. The volume of the application solution delivered into each tree was recorded. The injection system was removed from the tree on day 7. Trees with an uptake of <80% of nominal from cumulative applications were excluded from residue sampling.

The application details for treatments T1, T2, T3, and T4 for each of the 8 sites used in the study are shown in Tables 12-15. The actual average dose taken up by the trees is reported in addition to the nominal dose to document that the sampled trees had achieved a minimum of 80% of the cumulative nominal dose.

TABLE 12
Treatment Table for Plots Treated with T1

| | | | | Average Rate per | Total Rate |
|---|---|---|---|---|---|
| | End-use Product | | | Application | mg/tree^{c} |
| | (concentration a.i., | Date | RTI^{a} | mg/tree^{b} | (% of total |
| Trial ID | nominal) | of Application | (days) | (% of application rate) | application rate) |
| 01 | ArborBiotic ™ | 29-Mar | — | 93.4 | 186.5 |
| | (94.8 mg/tree/ | | | (98.5%) | (98.4%) |
| | injection) | 14-Jun | 77 | 93.2 | |
| | | | | (98.3%) | |
| 02 | ArborBiotic ™ | 28-Apr | — | 79.0 | 168.2 |
| | (94.8 mg/tree/ | | | (83.3%) | (88.7%) |
| | injection) | 14-Jun | 47 | 89.2 | |
| | | | | (94.0%) | |
| 06 | ArborBiotic ™ ™ | 30-Mar | — | 92.5 | 174.8 |
| | (94.8 mg/tree/ | | | (97.6%) | (92.2%) |
| | injection) | 14-Jun | 76 | 82.2 | |
| | | | | (86.7%) | |
| 07 | ArborBiotic ™ | 30-Mar | — | 93.7 | 187.0 |
| | (94.8 mg/tree/ | | | (98.9%) | (98.6%) |
| | injection) | 08-Jun | 70 | 93.2 | |
| | | | | (98.3%) | |
| 08 | ArborBiotic ™ | 29-Mar | — | 91.6 | 185.8 |
| | (94.8 mg/tree/ | | | (96.7%) | (98.0%) |
| | injection) | 15-Jun | 78 | 93.2 | |
| | | | | (98.3%) | |

Note:
T1 Applications comprised of two rootstock injection applications each of 94.8 mg ArborBiotic ™/tree (37.5 mg OTC-HCl/tree) as an aqueous solution of 60 ml - 1 container/tree
^{a}RTI = Retreatment Interval. Number of days between the two applications.
^{b}The rate indicated is the actual application rate achieved, expressed as the average uptake achieved in the treated trees in the test plot at each application timing.
^{c}The Total Rate mg/tree is calculated using only the trees that remained in the study following the 2^{nd} application. This value is not the sum of the average rate per application in the first and second applications.

TABLE 13
Treatment Table for Plots Treated with T2

| | | | | Average Rate per | Total Rate |
|---|---|---|---|---|---|
| | End-use Product | | | Application | mg/tree^{c} |
| | (concentration a.i., | Date | RTI^{a} | mg/tree^{b} | (% of total |
| Trial ID | nominal) | of Application | (days) | (% of application rate) | application rate) |
| 01 | ArborBiotic ™ | 29-Mar | — | 174.7 | 361.7 |
| | (189.6 mg/tree/ | | | (92.1%) | (95.4%) |
| | injection) | 14-Jun | 77 | 187.0 | |
| | | | | (98.6%) | |
| 02 | ArborBiotic ™ | 28-Apr | — | 172.6 | 359.2 |
| | (189.6 mg/tree/ | | | (91.0%) | (94.7%) |
| | injection) | 14-Jun | 47 | 186.6 | |
| | | | | (98.4%) | |
| 06 | ArborBiotic ™ | 30-Ma | — | 182.4 | 335.6 |
| | (189.6 mg/tree/ | | | (96.2%) | (88.5%) |
| | injection) | 14-Jun | 76 | 153.1 | |
| | | | | (80.8%) | |
| 07 | ArborBiotic ™ | 30-Mar | — | 168.1 | 351.1 |
| | (189.6 mg/tree/ | | | (88.6%) | (92.6%) |
| | injection) | 08-Jun | 70 | 183.1 | |
| | | | | (96.6%) | |
| 08 | ArborBiotic ™ | 29-Mar | — | 169.1 | 346.0 |
| | (189.6 mg/tree/ | | | (89.2%) | (91.3%) |
| | injection) | 15-Jun | 78 | 177.0 | |
| | | | | (93.3%) | |

Note:
T2 Applications comprised of two rootstock injection applications each of 189.6 mg ArborBiotic ™/tree (75.1 mg OTC/tree) as an aqueous solution of 120 ml - 2 cannisters/tree
^{a}RTI = Retreatment Interval. Number of days between the 2 applications.
^{b}The rate indicated is the actual application rate achieved, expressed as the average uptake achieved in the treated trees in the test plot at each application timing.
^{c}The Total Rate mg/tree is calculated using only the trees that remained in the study following the 2^{nd} application. This value is not the sum of the average rate per application in the first and second applications.

TABLE 14
Treatment Table for Plots Treated with T3

| | | | | Average Rate per | Total Rate |
|---|---|---|---|---|---|
| | End-use Product | | | Application | mg/tree^{c} |
| | (concentration a.i., | Date | RTI^{a} | mg/tree^{b} | (% of total |
| Trial ID | nominal) | of Application | (days) | (% of application rate) | application rate) |
| 01 | ArborBiotic ™ | 29-Mar | — | 182.5 | 369.5 |
| | (189.0 mg/tree/ | | | (96.6%) | (97.8%) |
| | injection) | 14-Jun | 77 | 187.0 | |
| | | | | (98.9%) | |
| 02 | ArborBiotic ™ | 28-Apr | — | 154.4 | 315.0 |
| | (189.0 mg/tree/ | | | (81.7%) | (83.3%) |
| | injection) | 14-Jun | 47 | 176.4 | |
| | | | | (93.3%) | |
| 06 | ArborBiotic ™ | 30-Mar | — | 177.1 | 325.9 |
| | (189.0 mg/tree/ | | | (93.7%) | (86.2%) |
| | injection) | 14-Jun | 76 | 148.2 | |
| | | | | (78.4%) | |
| 07 | ArborBiotic ™ | 30-Mar | — | 172.8 | 356.5 |
| | (189.0 mg/tree/ | | | (91.4%) | (94.3%) |
| | injection) | 08-Jun | 70 | 185.9 | |
| | | | | (98.3%) | |
| 08 | ArborBiotic ™ | 29-Mar | — | 187.1 | 373.6 |
| | (189.0 mg/tree/ | | | (99.0%) | (98.8%) |
| | injection) | 15-Jun | 78 | 186.5 | |
| | | | | (98.7%) | |

Note:
T3 Applications comprised of two rootstock injection applications each of 189.0 mg ArborBiotic ™/tree (74.8 mg OTC/tree) as an aqueous solution of 60 ml - 1 cannister/tree
^{a}RTI = Retreatment Interval. Number of days between the 2 applications.
^{b}The rate indicated is the actual application rate achieved, expressed as the average uptake achieved in the treated trees in the test plot at each application timing.
^{c}The Total Rate mg/tree is calculated using only the trees that remained in the study following the 2^{nd} application. This value is not the sum of the average rate per application in the first and second applications.

TABLE 15
Treatment Table for Plots Treated with T4

| | | | | Average Rate per | Total Rate |
|---|---|---|---|---|---|
| | End-use Product | | | Application | mg/tree^{c} |
| Trial | (concentration a.i., | Date | RTI^{a} | mg/tree^{b} | (% of total |
| ID | nominal) | of Application | (days) | (% of application rate) | application rate) |
| 01 | ArborBiotic ™ | 29-Mar | — | 349.3 | 349.3 |
| | (378.0 mg/tree/ | | | (92.4%) | (92.4%) |
| | injection) | | | | |
| 02 | ArborBiotic ™ | 28-Apr | — | 321.3 | 321.3 |
| | (378.0 mg/tree/ | | | (85.0%) | (85.0%) |
| | injection) | | | | |
| 06 | ArborBiotic ™ | 30-Mar | — | 359.6 | 359.6 |
| | (378.0 mg/tree/ | | | (95.1%) | (95.1%) |
| | injection) | | | | |
| 07 | ArborBiotic ™ | 30-Mar | — | 348.4 | 348.4 |
| | (378.0 mg/tree/ | | | (92.2%) | (92.2%) |
| | injection) | | | | |
| 08 | ArborBiotic ™ | 29-Mar | — | 371.7 | 371.7 |
| | (378.0 mg/tree/ | | | (98.3%) | (98.3%) |
| | injection) | | | | |

Note:
T4 Applications comprised of 1 rootstock injection applications of 378.0 mg ArborBiotic ™/tree (149.7 mg OTC/tree) as an aqueous solution of 120 ml - 2 cannisters/tree
^{a}RTI = Retreatment Interval. Not applicable for T4 plots, only 1 application was made per tree.
^{b}The rate indicated is the actual application rate achieved, expressed as the average uptake achieved in the treated trees in the test plot at each application timing.
^{c}The Total Rate mg/tree is calculated using only the trees that remained in the study following the 1^{st} application.

Sampling Method. From the control plots (UTC), a single composite sample was collected from sites 01, 02, 04, 05, 06, and 08; a RAC sample of 24 fruit was collected from sites 01, 02, 04, 05, 06, and 08; and a bulk, 200 kg sample was collected from site 04. From the treated plots (T1, T2, T3, T4) of the sites sampled, duplicate composite RAC samples of 24 fruit each were collected. During sampling, the control and treated samples were always separated by adequate space to avoid contamination. Samples were collected from all four quadrants from inside to the outside of the canopy, and from high to low.

Sampling Timing. Citrus were collected following the timing in Table 16 (samples were only collected from trial locations).

TABLE 16
Summary of Sample Timing

| | Sampling | | Minimum |
|---|---|---|---|
| Plot ID | Interval^{a} | Commodity | Sample Size^{b} |
| UTC | 90 DALA | Citrus, Immature Fruit | 24 Fruit/100 g |
| UTC | ENCH | Citrus, Whole Fruit | 24 Fruit/2 kg |
| T1, T2, T3, T4 | 90 DALA | Citrus, Immature Fruit | 24 Fruit/100 g |
| T1, T2, T3, T4 | 90 DALA | Citrus, Immature Fruit | 24 Fruit/100 g |
| T1, T2, T3, T4 | ENCH | Citrus, Whole Fruit | 24 Fruit/2 kg |
| T1, T2, T3, T4 | ENCH | Citrus, Whole Fruit | 24 Fruit/2 kg |

^{a}DALA = Days After Last Application; ENCH = Earliest Normal Commercial Harvest
^{b}Sample size consists of at least 24 fruit items and meets the weight requirement.

Residue Analysis. Oxytetracycline (OTC) and 4-Epi-Oxytetracycline analytes were measured in study samples according to methods described in Robaugh, E. “A Method for the Determination of Oxytetracycline and 4-Epi-Oxytetracycline in Apples, Pears, Peaches, and Nectarines by LC/MS/MS.” 2013.

### Results

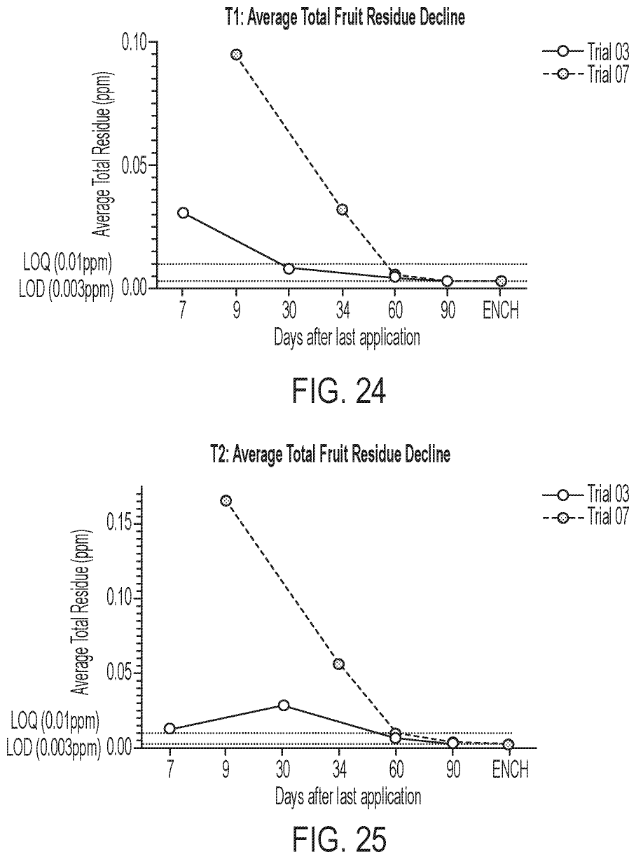

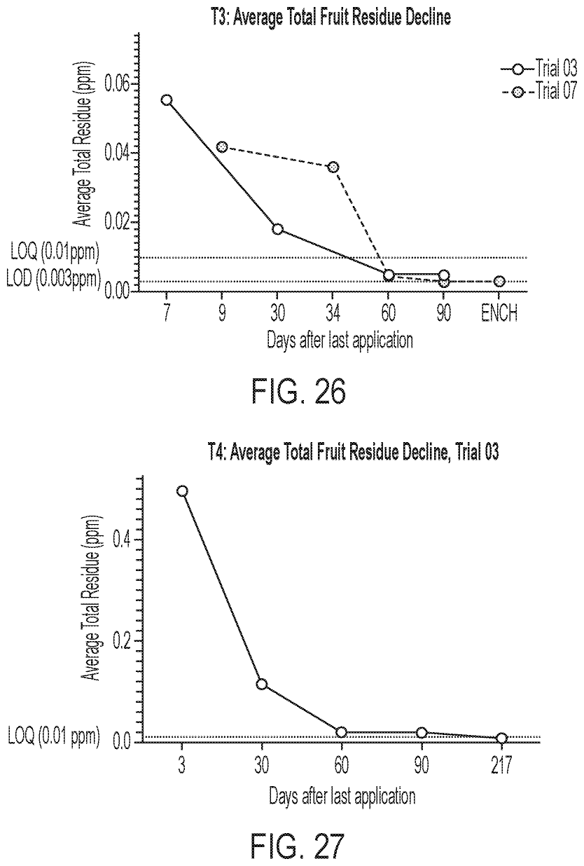

Residue Decline Studies. Residue decline data are graphically represented in FIGS. 24-27 for the four treatments and the sites ID 3 (T1-T4) and ID 7 (T1-T3). Treatments T1, T2, and T3 with duplicate injections of either 2× 37.5 mg (T1) or 2× 75 mg (T2 and T3) of OTC-HCl per tree show consistently initial total residue levels of less than 0.20 ppm at 3 days after application in immature fruit and decline to levels at or below 0.01 ppm by day 60 to 90 after the last injection. There is no measurable difference between the low rate (T1) and the higher rates used in T2 and T3 as duplicate applications. The single high dose in T4 created significantly higher initial concentration of 0.5 ppm in immature fruit at 3 days followed by comparatively faster decline than observed in treatments T1-T3; the kinetics, however, were insufficient to provide complete dissipation of the residue to levels at or below 0.01 ppm by 90 DALA.

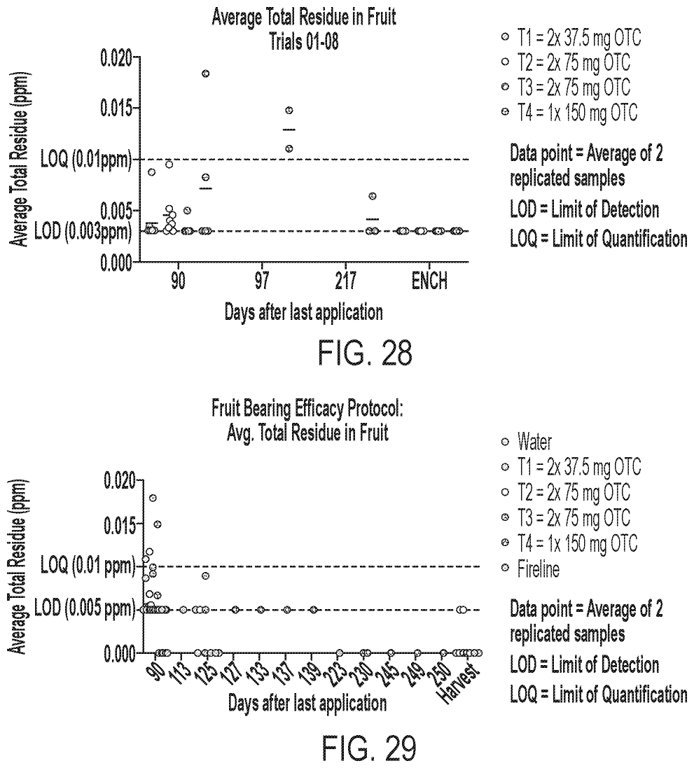

Fruit Residues at 90 Days After Last Application (DALA) and Earliest Normal Commercial Harvest. Residue results (average from two replicate samples) at 90 days after the last treatment and at later dates up to Earliest Normal Commercial Harvest (ENCH) were determined. Average residue levels from two replicated samples at day 90 following treatments T1, T2, and T3 were at or below the current tolerance of 0.01 ppm for OTC in Citrus at all eight site locations (FIG. 28). Treatment T4 had 3 detects above 0.01 ppm at DALA 90 and 97. Residues exceeding 0.01 ppm were observed at sites 03, 07, and 08. At ENCH, fruit residues from all treatments were below the LOD of 0.003 ppm for samples and treatments collected to date.

The residue data indicates that treatments T1, T2, and T3 are compatible with the current tolerance of 0.01 ppm if a PHI of 90 days is considered. Treatment T4 will require a slightly longer PHI to meet the tolerance target.

### Example 5: Field Trial—Study of the Magnitude of Residues of OTC and its Metabolite in Orange Raw Agricultural Commodities and Leaves

This example demonstrates that the residue levels of oxytetracycline hydrochloride (OTC-HCl) in the fruit and leaves of orange trees following an injection of ArborBiotic™ the trunk of the tree using an exemplary injection system as described herein, decline substantially before the end of the crop cycle. The fruit and leaf residue data in this Example was generated from orange trees (Valencia, OLL8, or Hamlin) with treatments described in Examples 2 and 3 during season 2 at nine trial location sites (01-09). The fruit residue data is generated from trial location sites 01-09 and the leaf residue data is generated from trial location sites 01, 02, 03, 05, 08, and 09. The fruit and leaf residue data in this Example was generated from orange trees (Valencia, OLL8, or Hamlin) with treatments described in Examples 2 and 3 during season 2 at nine trial location sites (01-09). The fruit residue data is generated from trial location sites 01-09 and the leaf residue data is generated from trial location sites 01, 02, 03, 05, 08, and 09.

Trial location site 09 was treated according to Example 2 (ArborBiotic™ and water as a negative control). Trial location sites 01-08 were treated according to Example 3 (ArborBiotic™, water as a negative control, and FireLine™ 17 WP as a positive control and commercial reference). Fruit Residue Analysis. Oxytetracycline hydrochloride (OTC-HCl) and 4-Epi-Oxytetracycline analytes were measured in orange fruit study samples according to methods described in Robaugh, E. 2013. “A Method for the Determination of Oxytetracycline and 4-Epi-Oxytetracycline in Apples, Pears, Peaches, and Nectarines by LC/MS/MS.”. Study matrices analyzed included orange immature fruit and mature whole fruit for the data reported.

Leaf Residue Analysis. Oxytetracycline (OTC-HCl) was measured in orange leaf disc samples according to the methods described in Nazari, B. 2022, “Determination of Oxytetracycline in Citrus Leaf Using LC-MS/MS”.

Fruit Residues at 90-250 DALA and Harvest. For each sampling date, one composite sample was collected and analyzed twice for two replicate results. The two results were then averaged to give an average mean value residue concentration, representative for the treatment and sampling date. Residue results (average from two replicate results) at 90 days after the last application and later collection dates until harvest are shown in FIG. 29. It should be understood that “Average Total Residue” includes OTC-HCl) and 4-Epi-Oxytetracycline analytes. The current data set suggests a PHI of 120 days to meet the tolerance target.

Key observations from the injection of ArborBiotic™ with an exemplary tree injection system as described herein with 4 different treatment regimens were as follows. Rapid uptake and distribution of the active ingredient OTC-HCl into the tree canopy was observed, with typical highest concentrations measured at days 1-3 following injection. Average leaf concentrations of OTC-HCl observed were 0.875 ppm for treatment T1, 1.558 ppm for treatment T2, and 1.637 ppm for treatment T3. For treatment T4, data was available from only 2 sites which were highly variable. Average concentrations ranged from 0.957 ppm at site 03 to 4.524 ppm at site 08. Average concentration between T1 and T2-T3 showed the expected dose response of 2×. Once peak OTC-HCl concentrations in leaves have been achieved they are followed by a moderately fast decline with average half-lives ranging from 6.2 days (T2) to 10.5 days (T1) with no apparent differences between T1-T4 regimes. At day 58-63 the average concentration over all treatments and locations is at less than the LOQ of 0.1 ppm. Residue levels in leaves following injection applications T1-T4 with an average leaf residue level of 1.346 ppm were about two times higher than average residue levels found in samples taken at day 1-3 from the FireLine™ 17 WP Spray treatment showing an average leaf residue level of 0.751 ppm. FireLineTM leaf residues declined rapidly with a greater than 70% decline from an average residue level of 0.751 ppm at day 1-3 to an average level of 0.204 ppm by day 6-8.

The leaf residue data demonstrates that the injection of ArborBiotic™ into orange trees using an injection system as described herein ensures rapid uptake and distribution into the tree canopy. Peak residue levels in leaves are about 2 times higher compared to levels achieved with contemporaneous foliar application of FireLine™ 17 WP. Residues from foliar applied OTC-HCl will dissipate rapidly (>70% in 5 days) from treated leaves. Injection treatments with oxytetracycline hydrochloride, however, will sustain elevated levels of OTC-HCl in leaf tissues but will decline to levels below the LOQ prior to the following application. The observed decline kinetics with average half-lives ranging from 6.2-10.5 days for ArborBiotic™ with an exemplary injection system as described herein suggest that leaf residues will decline quantitatively by the end of the crop cycle. Dropping leaves from ArborBiotic™ injected trees will therefore not become a source for low-level environmental contamination and create a potential resistance risk for non-target microorganisms.

### Example 6: Field Trial—Study of the Magnitude of Residues of OTC-HCL and its Metabolite in Orange Tree Root

This example demonstrates that injections of ArborBiotic™ to the trunk of an orange tree using an exemplary injection system as described herein will not create environmentally relevant concentrations of-HCl in the roots of the treated orange trees.

Field trial design. A field trial was conducted by applying treatments to commercial orange trees (Valencia variety) at two different trial site locations. Treatments included the application of ArborBiotic™ using an exemplary injection system as described herein into the scion of each tree, treatment with water (used as a negative control), and treatment with a commercially available product FireLine™ 17 WP (used as a positive control and commercial reference).

Treatments. Treatments were injected into the trunk of the orange trees. A full list of the treatments used in the study are included in Table 17. For treatment A (TA), each application included two injections of 94.8 mg ArborBiotic™ in 60 mL of distilled water (for a total of 189.6 mg of ArborBiotic™ and 120 mL of distilled water), which delivered a total dose of 75.1 mg of OTC-HCl per application per tree. Treatment 4 (T4) was applied in a single application including two injections of 189.0 mg ArborBiotic™ in 60 mL of distilled water (for a total of 378.0 mg of ArborBiotic™ and 120 mL of distilled water), which delivered a total dose of 149.7 mg of OTC-HCl per application per tree. Two applications of all treatments were applied during the growing season. The first applications were made in June or July and the second applications were made between September to November.

TABLE 17
Treatments

| | | Total | | Total OTC- | Number of | Total OTC- |
|---|---|---|---|---|---|---|
| | Active | ArborBiotic ™ | # injections/ | HCl (mg/ | applications/ | HCl per |
| Treatment | ingredient | (mg/injection) | application | injection) | season | season (mg) |
| Water | n/a | n/a | 2 | n/a | 2 | n/a |
| TA | ArborBiotic ™ | 94.8 | 2 | 37.5 | 2 | 150.2 |
| TB | ArborBiotic ™ | 189.0 | 2 | 149.7 | 2 | 399.4 |
| FireLine ™ | FireLine ™ | n/a | n/a | | 2 | |
| Spray | | | | | | |

Location. Two locations representative of commercial citrus growing areas were chosen for this study. Each trial site included 16 plots: 4 negative control plots (water treatment) and 4 treated plots for each of the three treatments (TA, TB, FireLine™ 17 WP Spray). The plots were large enough to ensure sufficient quantity of representative specimens and material for residue analysis. Treatments contained 4 replicated plots each. All treatments had 1 tree per plot, a total of 4 trees per treatment. Each tree was clearly identified, with a unique number (such as Experiment No., Plot No., and Tree No). FireLine™ 17 WP Spray was placed in an adjacent block where a commercial sprayer applied the product. Due to the application method. A larger buffer between negative control (water treatment) and treated plots for Treatment A and Treatment B was not required. No other formulations containing OTC-HCl were applied during the trial period.

Application Method. The application method of the water treatment, TA, and TB was tree trunk injections using an exemplary injection system as described herein. The application vehicle was bottled deionized water. The application solution was prepared on the day of application. Each container was uniquely identified. The volume of the application solution delivered into each tree was recorded. The device was removed from the tree on day 7-9. Treatment with FireLine™ 17 WP Spray was applied using a commercial sprayer at a label rate of 24 oz/acre (equivalent to 4.08 ounces of OTC-HCl per acre) and the solution was prepared on the day of the application according to label recommendations. Treatment with FireLine™ 17 WP coincided with the other treatment applications. The sampled trees had achieved a minimum of 80% of the cumulative nominal dose.

### Root Residue Analysis and Results

OTC residues were measured in study samples according to methods described in Nazari, B. 2022, “Determination of Oxytetracycline in Orange Tree Root Using LC-MS/MS”. Orange tree root samples were analyzed for the study.

This example demonstrates that systemic OTC concentrations in leaves of treated trees reach the concentration maximum within 2-3 days after injection and subsequently decline with mean half-life values ranging from 6-10 days. Based on the data obtained during this study, duplicate injection of ArborBiotic™ performed with an exemplary injection system as described herein at rates of up to 378 mg per tree (149.7 mg OTC-HCl per tree) will not create environmentally relevant concentrations in the roots of treated orange trees. Due to the absence of OTC-HCl residues in roots, it can be excluded that the soil environment surrounding the three roots will be contaminated by traces of OTC-HCl through root exudates.

### Additional Data

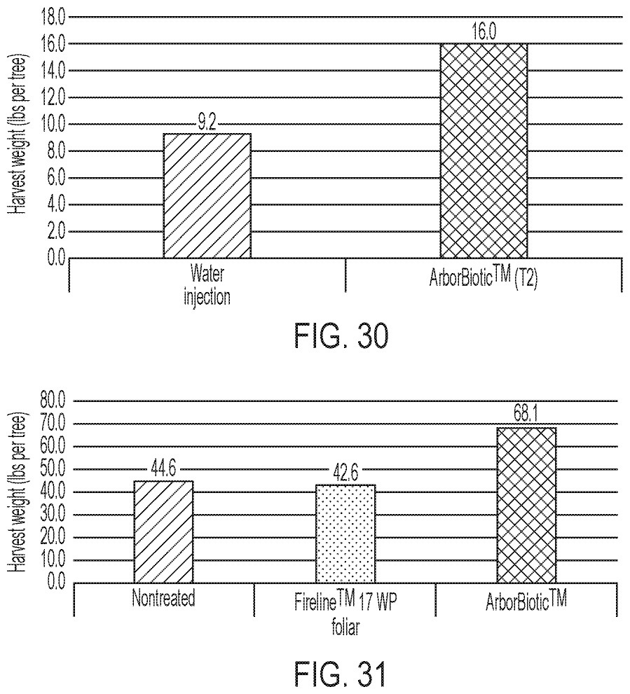

Some additional data and results are provided in FIGS. 30-32 with respect to the aforementioned examples, e.g., Examples 2-6.

In FIG. 30, the OTC-HCl treatment showed about 74% yield increase over water. The treatment delivered 150 mg OTC-HCl per season.

In FIG. 31, the OTC-HCl treatment showed bout 53% yield increase over the nontreated controls. The treatment delivered 600 mg OTC-HCl per season.

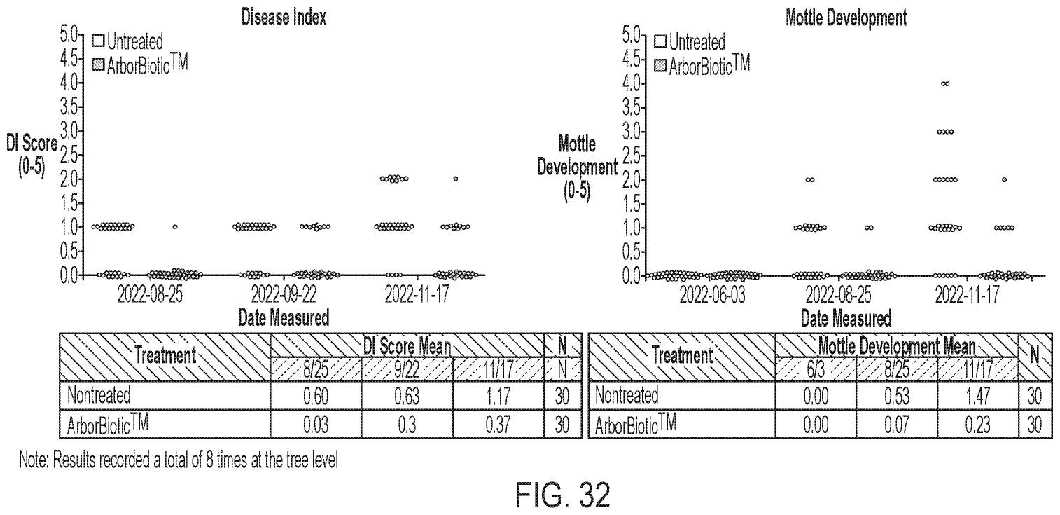

In FIG. 32, the OTC-HCl treatment resulted in lower disease and leaf mottling as compared to the nontreated controls. Visible treatment differences were observed on new transplants in the two-year trial. Trees treated over three applications (injections using an exemplary injection system as described herein) over a two-year trial, with 19 mg of OTC HCl each time, totaling 56 mg of OTC HCl.

### Example 7: Field Trial-Efficacy of OTC Treatments on Citrus Trees with a Scion Diameter Within the Range of 1.3 to 5.1 cm

This study was conducted to test the efficacy of injection formulations comprising oxytetracycline hydrochloride as active ingredient against Huanglongbing (HLB) infections on young citrus trees with a scion diameter within the range of 0.5 to 2.0 inches (1.3 to 5.1 cm).

The study was conducted at two field trial locations over two seasons. A total of 12 orange trees were tested per treatment at each location. A summary of the treatments are provided at Table 18 below. Treatments included rootstock injections of ArborBiotic™, a foliar application of FireLine™ 17 WP (FireLine Spray), a registered OTC product manufactured by AgroSource (AgroSource, Inc, P.O. Box 3091, Tequesta, FL 33469), and a rootstock injected Water treatment (negative control). The injections were performed with 6.5 mm injection tools connected to 50 ml bag-on-valve canisters containing the injection formulation in season 1 and 6.5 mm injection tools connected to 100 ml containers bag-on-valve canisters containing the injection formulation in seasons 2.

TABLE 18
Summary of Treatments

| | | | | | | | Total | Total |
|---|---|---|---|---|---|---|---|---|
| | | | | | Number of | Volume/ | OTC-HCL | OTC-HCL |
| | Active | Product | OTC-HCL | #injections/ | applications | tree | (mg) per | (mg) per |
| Treatment | Ingredient | (mg/ml) | (mg/ml) | applications | per season | (ml) | application | season |
| Negative | Water | n/a | n/a | 1 | 2 | 30 | n/a | n/a |
| control | | | | | | | | |
| T1 | ArborBiotic | 1.58 | 0.625 | 1 | 2 | 30 | 37.5 | 75 |
| T2 | ArborBiotic | 3.15 | 1.25 | 1 | 2 | 30 | 75 | 150 |
| FireLine | FireLine* | | 0.33 | n/a | 2 | 1890 | n/a | 625 |
| spray | | | | | | | | |

*FireLine values are estimates based on label application rates and approximate number of trees per acre.

Treatment efficacy was determined based on evaluation of the development of disease symptoms. Disease symptoms were evaluated by analyzing the amount of leaf mottling appearing on young leaves from infection of HLB. Leaf mottling is an early visible symptom of HLB infection that occurs when carbohydrates cannot be transported through damaged phloem tissue in the leaf. A 0-5 rating scale was used to estimate the percent of fully hardened leaves that show mottling symptoms. In this scale, 0 rating=no visible mottle on any leaves in a tree, 1=<20%, 2=21-40% , 3=40-60%, 4=60-80%, and 5=>80% of leaves showing mottle symptoms. These ratings are best performed after the major flushes have expanded and hardened off usually in early summer (June), late summer (August), and after the fall flush matures (November) (Gottwald, et al.). The results of ANOVA showed that independent variables of Evaluation date, Treatment, and Evaluation date by Treatment had a statistically significant effect (P<0.10) on leaf mottle.

Across the four evaluation dates for leaf mottle, trees of the water-injected control and the foliar applied Fireline had significantly (P<0.10) more HLB mottling symptoms than the trees treated with 94.8 or 189.6 mg/ml ArborBiotic (37.5 or 75.0 mg OTC-HCL, respectively). The average leaf mottle score for the water injection and Fireline spray were 2.4 and 2.4 respectively and both ArborBiotic treatments had a mottling score of 1.6. See Table 19.

TABLE 19
Mean response by treatment across evaluation dates

| | Mg/ml ArborBiotic | | |
|---|---|---|---|
| | per tree per | Mean Leaf | Tukey's |
| Treatment | season | Mottle | grouping |
| Negative Control | n/a | 2.4 | A |
| (Water) | | | |
| FireLine | n/a | 2.4 | A |
| T1 | 37.5 | 1.6 | B |
| T2 | 75 | 1.6 | B |

What is claimed is:

1. A method for controlling citrus greening in a citrus plant, wherein the citrus plant further has an active vasculature that runs through the trunk or stem to other parts of the citrus plant, the method comprising:
injecting an injection formulation comprising oxytetracycline (OTC) or a salt thereof into the active vasculature of the plant to control citrus greening in the citrus plant.

2. The method of claim 1, wherein the active vasculature into which the injection formulation is injected is active vasculature in the trunk or stem of the citrus plant.

3. The method of claim 1, wherein the citrus plant is a citrus tree.

4. The method of claim 1, wherein, after injection, the citrus plant has at least about 5%, at least about 10%, or at least about 15%, or between about 10% and about 25% reduced fruit drop as compared to an untreated citrus plant.

5. The method of claim 1, wherein, after injection, the citrus plant produces fruit with at least about 1%, at least about 2%, at least about 3%, at least about 4%, or at least about 5%, between about 5% and about 10% increased Brix as compared to an untreated citrus plant.

6. The method of claim 1, wherein, after injection, the citrus plant has at least about 10%, at least about 20%, at least about 30%, at least about 40%, or at least about 50%, or between about 40% and about 75% increased fruit yield as compared to an untreated citrus plant.

7. The method of claim 1, wherein the injecting of the injection formulation is performed using an injection system comprising an injection tool operatively connected to a fluid delivery unit, wherein the fluid delivery unit is configured to deliver the injection formulation; and
wherein the injecting of the injection formulation comprises: piercing the trunk or stem of the citrus plant using the injection tool of the injection system; and delivering at least a portion of the injection formulation from the fluid delivery unit through the injection tool into and no further than the active vasculature of the citrus plant.

8. (canceled)

9. The method of claim 7, wherein the injection formulation is distributed throughout the trunk or stem and other parts of the citrus plant; and
wherein the other parts of the citrus plant comprise fruits and/or leaves.

10.-11. (canceled)

12. The method of claim 7, wherein the fluid delivery unit is a spring-loaded fluid delivery unit and/or wherein the fluid delivery unit comprises a pressurized formulation cartridge; and
wherein the method further comprises:
replacing the fluid delivery unit with a second fluid delivery unit; and
delivering at least a portion of the injection formulation from the second fluid delivery unit through the injection tool into and no further than the active vasculature of the citrus plant.

13.-14. (canceled)

15. The method of claim 7, wherein the injection tool remains in the trunk or stem of the citrus plant over at least one growing season; and/or wherein the injection tool remains in the trunk or stem of the citrus plant over multiple re-injections.

16. (canceled)

17. The method of claim 7, wherein the trunk of the citrus plant has bark, and the method further comprises:
removing at least a portion of the bark prior to piercing the trunk.

18. The method of claim 1, wherein the citrus plant is an orange tree; and
wherein:
the orange tree to which the injection formulation is applied having fruit with an average oxytetracycline (OTC) residue of less than about 0.01 ppm;
the orange tree to which the injection formulation is applied having an average fruit drop of less than about 20;
the orange tree to which the injection formulation is applied having an average fruit yield of at least about 40 lbs per plant, or between about 45 and about 90 lbs per plant;
the orange tree to which the injection formulation is applied having an average Brix of at least about 7.5;
the orange tree to which the injection formulation is applied having fruit with an average decrease in fruit drop by at least about 10% as compared to an orange tree to which the injection formulation has not been applied;
the orange tree to which the injection formulation is applied having fruit with an average increase in Brix by at least about 5% as compared to an orange tree to which the injection formulation has not been applied; and/or
the orange tree to which the injection formulation is applied having fruit with an average increase in fruit yield by at least about 10% as compared to an orange tree to which the injection formulation has not been applied.

19.-60. (canceled)

61. A method of treating citrus greening and leaf mottling in citrus plant with a scion diameter greater than 6 cm, wherein the citrus plant has an active vasculature that runs through the trunk or stem to other parts of the citrus plant, the method comprising:
injecting an injection formulation comprising oxytetracycline (OTC) or a salt thereof into the active vasculature of the citrus plant, wherein the injection formulation is injected into the citrus plant one or more times a growing season to reduce citrus greening.

62. The method of claim 61, wherein the citrus plant is injected once with an injection formulation comprising 150 mg oxytetracycline hydrochloride.

63. The method of claim 61, wherein the citrus plant is injected two times with an injection formulation comprising 75 mg oxytetracycline hydrochloride; and
wherein the injections are spaced between about 30 days and about 60 days apart.

64. The method of claim 61, wherein the citrus plant is injected three times with an injection formulation comprising 50 mg oxytetracycline hydrochloride; and
wherein the injections are spaced between about 30 days and about 60 days apart.

65.-67. (canceled)

68. The method of claim 61, wherein the citrus plant is injected in rootstock with an injection tool that reaches but does not exceed a depth of about 8.5 to 9 mm; and/or
wherein the citrus plant is injected in the scion with an injection tool that reaches but does not exceed a depth of 8.5 to 9 mm.

69. (canceled)

70. The method of claim 61, wherein the citrus plant is injected with 60, 70, 80, 90, 100, 110, or 120, 130, 140, 150, 160, 170, 180, 190, 200, 210, 220, 230, 240, or 250 mL of injection formulation.

71.-73. (canceled)

74. The method of claim 61, wherein, after injection, the citrus plant has at least about 5%, at least about 10%, or at least about 15%, or between about 10% and about 25% reduced fruit drop as compared to an untreated citrus plant.

75. The method of claim 61, wherein, after injection, the citrus plant produces fruit with at least about 1%, at least about 2%, at least about 3%, at least about 4%, or at least about 5%, between about 5% and about 10% increased Brix as compared to an untreated citrus plant.

76. The method of claim 61, wherein, after injection, the citrus plant has at least about 10%, at least about 20%, at least about 30%, at least about 40%, or at least about 50%, or between about 40% and about 75% increased fruit yield as compared to an untreated citrus plant.

77.-90. (canceled)
